(19) United States
(12) Patent Application Publication
(10) Pub. No.: US 2025/0382979 A1
(43) Pub. Date: Dec. 18, 2025

(54) PISTON-TYPE GAS-POWERED WELL-BASED ENERGY STORAGE AND POWER GENERATION SYSTEM

(71) Applicants: LUGUO ZHANG, URUMQI (CN); CHENXI ZHANG, URUMQI (CN); CHENYU ZHANG, URUMQI (CN)

(72) Inventors: LUGUO ZHANG, URUMQI (CN); CHENXI ZHANG, URUMQI (CN); CHENYU ZHANG, URUMQI (CN)

(73) Assignees: LUGUO ZHANG, URUMQI (CN); CHENXI ZHANG, URUMQI (CN); CHENYU ZHANG, URUMQI (CN)

(21) Appl. No.: 19/199,400

(22) Filed: May 6, 2025

Related U.S. Application Data
(63) Continuation of application No. PCT/CN2022/130439, filed on Nov. 7, 2022.

(51) Int. Cl. F15B 1/02; F15B 1/26; F15B 15/14; F15B 21/06

(52) U.S. Cl. CPC F15B 1/024; F15B 1/26; F15B 15/1447; F15B 21/06

(57) ABSTRACT

The present invention relates to a piston-type gas-powered well-based energy storage and power generation system, which comprises a gas-powered well, a lifting well, a falling well, a piston assembly, an isolation device, power generation equipment, and gravity blocks. This system utilizes the properties of ammonia gas and hydrogen chloride gas, which are highly soluble in water with large solubility capacity, to provide a power system independent of natural and resource constraints. The system lifts heavy gravity blocks for energy storage by means of the gas-powered well system and subsequently releases the stored gravitational energy for stable and sustained power generation. Alternatively, the power system can also be used for direct power generation or mechanical power output. The system enables grid-based, miniaturized, and modular power supply configurations, thereby eliminating the need for long-distance, cross-regional power transmission.

### TECHNICAL FIELD

The present invention relates to the technical field of energy storage and power generation, and more specifically to a piston-type gas-powered well-based energy storage and power generation system, as well as an energy storage and power generation method.

### BACKGROUND

Although wind power and solar power still have considerable development potential, due to their inherent drawbacks, they are unable to serve as the main power sources for the grid. For a long time in the future, thermal power generation will remain the dominant source of electricity for the grid. Traditional fossil fuels will continue to serve as the main and fundamental energy sources. However, the energy utilization efficiency of thermal power generation is generally around 40%. Moreover, the use of fossil fuels in thermal power generation brings a series of persistent challenges, including carbon emissions, environmental pollution, limited reserves, and transportation distance.

### SUMMARY

In the process of utilizing energy for power generation, the design of a novel energy storage and power generation system is proposed to enable construction of the system at any location, without being constrained by resources or natural conditions. The system employs readily available and recyclable resources, and ensures safety, environmental friendliness, and stable and reliable power generation. It further optimizes the power supply region by achieving grid-based, miniaturized, and modular power distribution, thereby avoiding long-distance power transmission across regions, reducing investment in power transmission lines and power losses, and enabling real-time adjustment of power generation load to match grid demand.

A piston-type gas-powered well-based energy storage and power generation system comprises a gas-powered well, a lifting shaft, a falling shaft, a piston assembly, an isolation device, power generation equipment, and gravity blocks.

The interior of the gas-powered well is provided with a sliding chamber for reciprocating motion of the piston assembly. A solution tank is arranged at the bottom of the sliding chamber. Independent gas injection, liquid injection, and liquid outlet pipelines are embedded in the wall of the gas-powered well. The gas injection pipeline is used to inject gas that is highly soluble in water into the gas-powered well. The outlet of the gas injection pipeline is located at the bottom of the sliding chamber. The outlet of the liquid injection pipeline is located at the bottom of the solution tank, and the inlet of the liquid outlet pipeline is also located at the bottom of the solution tank. A first truss beam is arranged at the top of the gas-powered well to support the piston assembly, and a first pulley is mounted on the first truss beam.

An ascending passage is provided inside the lifting shaft for lifting the gravity blocks. A second truss beam is arranged at the top of the lifting shaft, and a second pulley is mounted on the second truss beam.

A descending passage is provided inside the falling shaft for the descent of the gravity blocks. A third truss beam is arranged at the top of the falling shaft, and a third pulley is mounted on the third truss beam.

The tops of the lifting shaft and the falling shaft are connected via a track, and the bottoms of the lifting shaft and the falling shaft are connected via a tunnel. The tunnel allows gravity blocks to move from the bottom of the descending passage to the bottom of the ascending passage.

The piston assembly is located in the sliding chamber of the gas-powered well and comprises a piston block, a connecting frame, support rollers, and a connecting rope. The support rollers are mounted on the side wall of the piston block, and the piston block is connected to the inner wall of the sliding chamber via the support rollers. A sealing structure is arranged between the side wall of the piston block and the inner wall of the sliding chamber, positioned between a pair of support rollers. The connecting frame is fixed on the top of the piston block. One end of the connecting rope is fixed on the connecting frame, and the free end of the connecting rope is connected to the gravity block and extends through the first and second pulleys, hanging down into the lifting shaft.

The isolation device is located between the sliding chamber and the solution tank. The isolation device has a telescopic end surface that isolates the gas in the sliding chamber from contact with the liquid in the solution tank.

The power generation equipment is installed above the falling shaft. A drum is connected to the output shaft of the power generation equipment, and a steel wire rope is wound on the drum. One end of the steel wire rope is fixed to the drum, and the connection end of the steel wire rope, which is connected to the gravity block, extends through the third pulley and hangs down into the falling shaft.

The present invention also provides a piston-type gas-powered well-based energy storage and power generation system comprising a gas-powered well, a piston assembly, an isolation device, and power generation equipment.

The axis of the gas-powered well is arranged horizontally. The interior of the gas-powered well comprises a sliding chamber for reciprocating motion of the piston assembly. A solution tank is arranged on one side of the sliding chamber, forming an L-shaped structure with the sliding chamber. A truss column is provided on the other side of the gas-powered well for traction of the piston assembly, and a steering pulley is mounted on the truss column.

Independent gas injection, liquid injection, and liquid outlet pipelines are embedded in the wall of the gas-powered well. The gas injection pipeline is used to inject gas that is highly soluble in water into the gas-powered well. The outlet of the gas injection pipeline is located inside the sliding chamber. The outlet of the liquid injection pipeline and the inlet of the liquid outlet pipeline are both located at the bottom of the solution tank.

The power generation equipment is installed on the truss column, and a drum is connected to the output shaft of the power generation equipment.

The piston assembly is located in the sliding chamber of the gas-powered well and comprises a piston block, a connecting frame, support rollers, and a connecting rope. The support rollers are mounted on the side wall of the piston block. The piston block is connected to the inner wall of the sliding chamber via the support rollers. A sealing structure is arranged between the side wall of the piston block and the inner wall of the sliding chamber, positioned between a pair of support rollers. The connecting frame is fixed on top of the piston block. One end of the connecting rope is fixed on the connecting frame, and the other end is wound on the drum via the steering pulley.

The isolation device is located between the sliding chamber and the solution tank, and the isolation device has a telescopic end surface that isolates the gas in the sliding chamber from contact with the liquid in the solution tank.

The present invention further provides a piston-type gas-powered well-based energy storage and power generation system comprising a gas-powered well, a piston assembly, an isolation device, a connecting rod, a crankshaft, and power generation equipment.

The interior of the gas-powered well comprises a sliding chamber for reciprocating motion of the piston assembly. A solution tank is arranged at the bottom of the sliding chamber. Independent gas injection, liquid injection, and liquid outlet pipelines are embedded in the wall of the gas-powered well. The gas injection pipeline is used to inject gas that is highly soluble in water into the gas-powered well. The outlet of the gas injection pipeline is located at the bottom of the sliding chamber, while the outlet of the liquid injection pipeline and the inlet of the liquid outlet pipeline are located at the bottom of the solution tank.

The piston assembly is located in the sliding chamber of the gas-powered well and comprises a piston block, a connecting frame, support rollers, a connecting rod, and a crankshaft. The support rollers are mounted on the side wall of the piston block. The piston block is connected to the inner wall of the sliding chamber via the support rollers. A sealing structure is arranged between the side wall of the piston block and the inner wall of the sliding chamber, positioned between a pair of support rollers. The connecting frame is fixed on top of the piston block and is connected to the crankshaft via the connecting rod.

The isolation device is located between the sliding chamber and the solution tank and has a telescopic end surface that isolates the gas in the sliding chamber from contact with the liquid in the solution tank.

The output shaft of the power generation equipment is connected to one end of the crankshaft.

1. The piston-type gas-powered well-based energy storage and power generation system has very low requirements for stability. During the gas dissolution process in the power well, stability requirements are minimal and can be controlled. Heating for the decomposition of ammonium bisulfate does not require high stability and can be achieved using auxiliary power from solar or wind energy generation systems. It can also be integrated with thermal power plants, utilizing waste heat from thermal power to heat ammonium bisulfate. Alternatively, heating can be done using fossil fuels such as coal, and the efficiency is still much higher than that of conventional thermal power, which is constrained by the Carnot cycle and generally has an energy conversion efficiency of about 40%, while the energy conversion efficiency of this invention can exceed 90%.

2. In the piston-type gas-powered well-based energy storage and power generation system, a solution is arranged at the bottom of the power well, and a piston system is installed inside the well. Easily water-soluble gases such as ammonia or hydrogen chloride are injected into the well, while the piston is lifted. When the piston reaches the upper limit position, the pressure of the gas injected into the well is maintained at standard atmospheric pressure. The rubber bag isolating the gas from the solution is then opened, allowing the gas to contact the solution. During the dissolution process, the internal pressure of the well decreases. Due to atmospheric pressure from above the piston, the piston begins to move downward. As it moves down, it lifts the gravity block from a lower to a higher position. Once the piston reaches the lower limit of the well, the gravity block is positioned at the highest point. The block is then moved horizontally to the falling shaft, where it descends by gravity, thereby driving the generator to produce electricity. This system can be constructed anywhere, is free from resource and environmental constraints, uses simple and recyclable resources, is safe, environmentally friendly, and capable of stable and reliable power generation. It also enables optimization of power supply regions by realizing grid-based, modular, and localized power delivery, avoiding long-distance power transmission across regions, reducing transmission line investment and power loss, and allowing for real-time adjustment of power generation load to match electricity consumption.

### BRIEF DESCRIPTION OF THE DRAWINGS

FIG. 1 is a schematic top plan view of an underground layout of a PISTON-TYPE GAS-POWERED WELL-BASED ENERGY STORAGE AND POWER GENERATION SYSTEM according to an embodiment of the present invention;

FIG. 2 is a longitudinal sectional view of the PISTON-TYPE GAS-POWERED WELL-BASED ENERGY STORAGE AND POWER GENERATION SYSTEM shown in FIG. 1;

FIG. 3a is a partially enlarged view of area A in FIG. 2;

FIG. 3b is a schematic view of the internal structure of a ventilation pipe;

FIG. 3c is a schematic layout view of the ventilation pipe;

FIG. 3d is a schematic assembly view of the isolation device and the solution tank;

FIG. 3e is a sectional structural view of the tunnel;

FIG. 4 is a schematic internal view of the ammonia gas-powered well;

FIG. 5 is a schematic internal view of the lifting shaft;

FIG. 6 is a schematic internal view of the falling shaft;

FIG. 7 is a schematic assembly view of the mixing tank;

FIG. 8 is a schematic top plan view of a ground-level, hillside-adjacent layout of the PISTON-TYPE GAS-POWERED WELL-BASED ENERGY STORAGE AND POWER GENERATION SYSTEM according to an embodiment of the present invention;

FIG. 9 is an elevation schematic view of the PISTON-TYPE GAS-POWERED WELL-BASED ENERGY STORAGE AND POWER GENERATION SYSTEM shown in FIG. 8;

FIG. 10a is a schematic view of the ammonia gas-powered well shown in FIG. 8;

FIG. 10b is a schematic view of the lifting track shown in FIG. 8;

FIG. 10c is a schematic view of the descending track shown in FIG. 8;

FIG. 10d is a schematic view of the hydrogen chloride gas-powered well shown in FIG. 8;

FIG. 11 is a schematic structural view of a horizontally laid-out piston-type gas-powered well-based energy storage and power generation system according to an embodiment of the present invention;

FIG. 12a is a schematic view showing the piston located at the top of the sliding chamber in a piston-type gas-powered well-based energy storage and power generation system with connecting rods and crankshafts;

FIG. 12b is a schematic view showing the piston located at the middle of the sliding chamber in the system shown in FIG. 12a;

FIG. 12c is a schematic view showing the piston located at the bottom of the sliding chamber in the system shown in FIG. 12a;

FIG. 13 is a schematic view of a layout in which multiple gas-powered wells are arranged in parallel in a piston-type gas-powered well-based energy storage and power generation system with connecting rods and crankshafts;

FIG. 14 is a schematic top plan view of an ammonia and hydrogen chloride gas regeneration system;

FIG. 15 is a schematic internal view of the reaction tank;

FIG. 16 is a schematic assembly view of the reaction tank.

### DETAILED DESCRIPTION

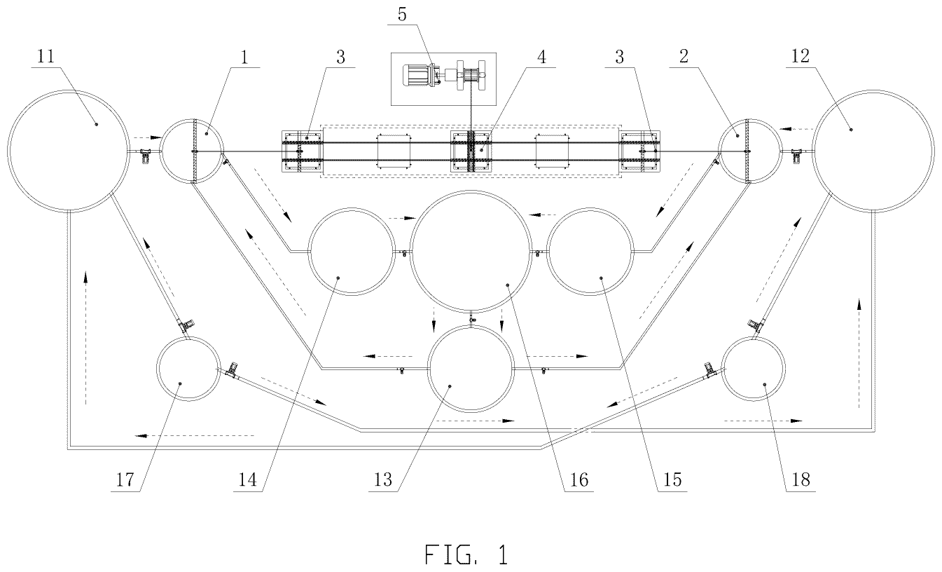

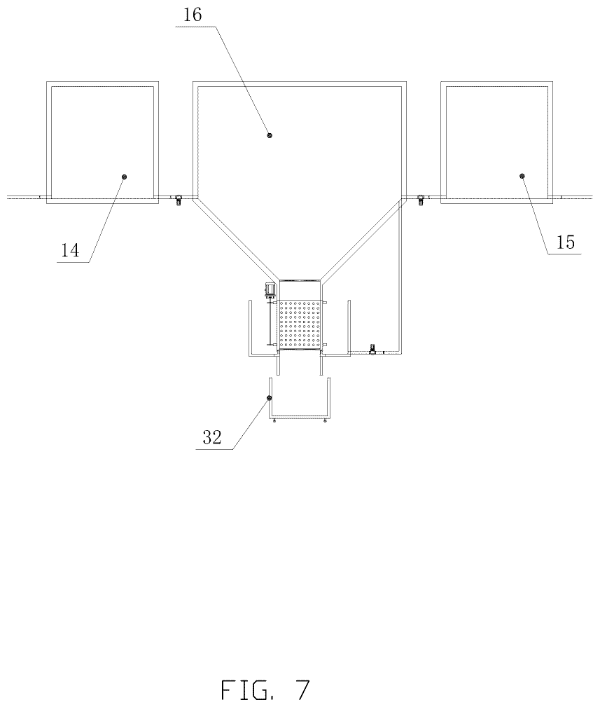

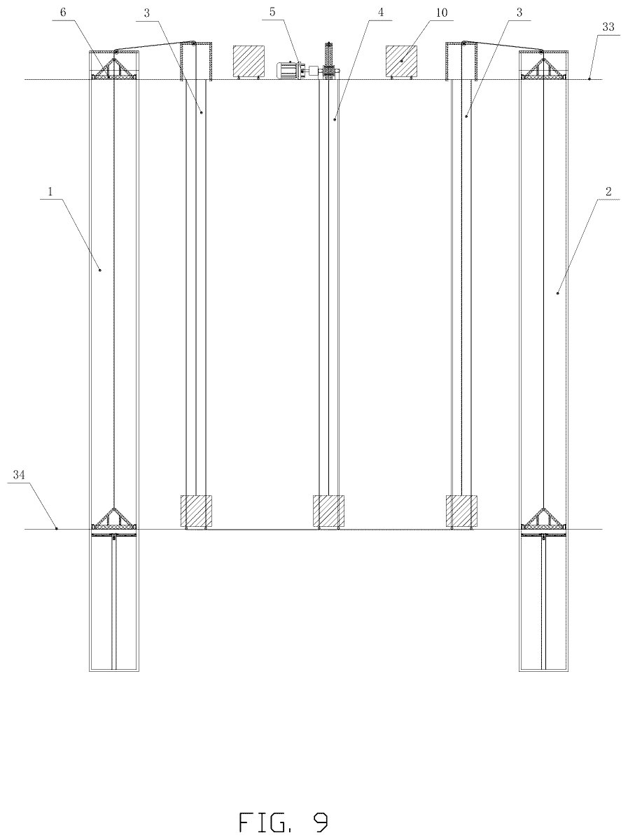

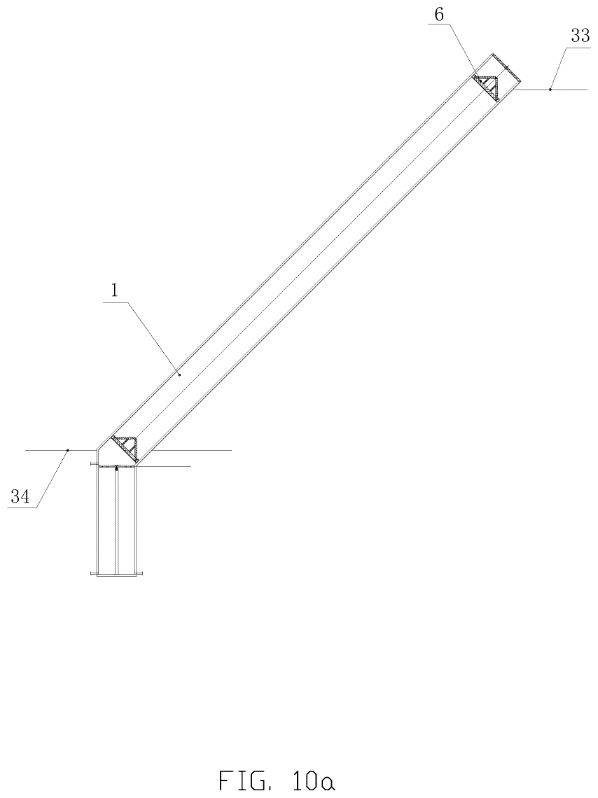

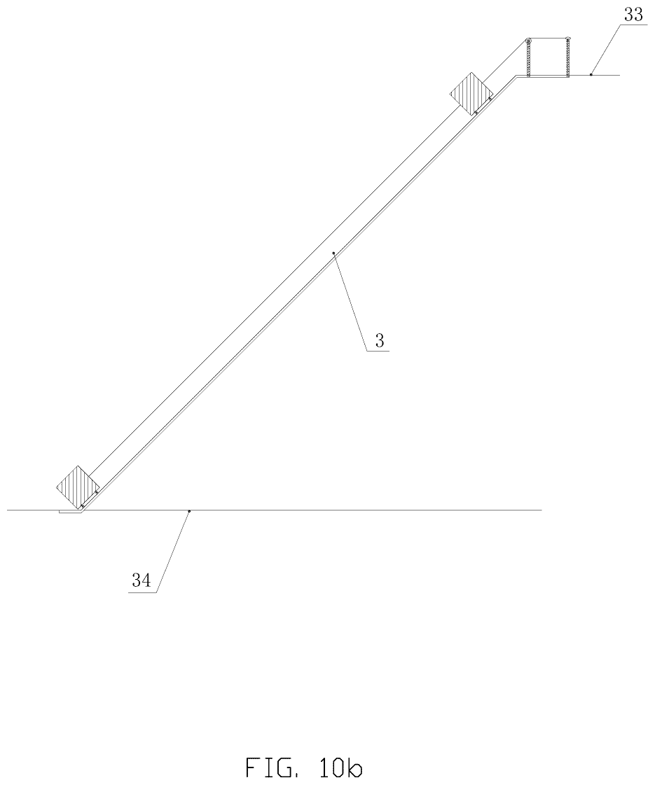

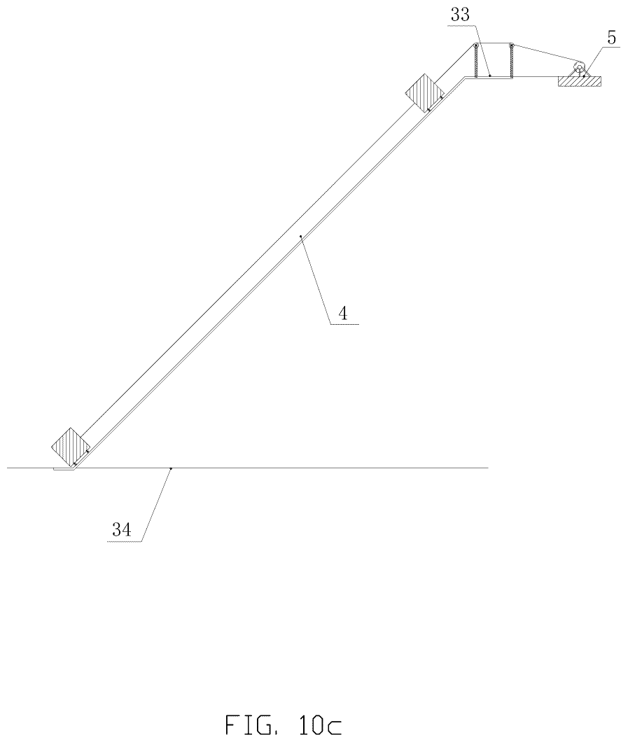

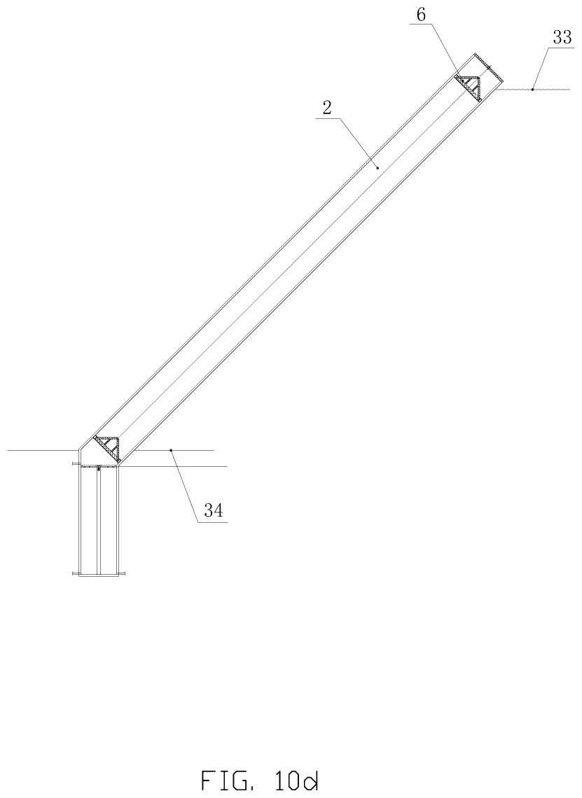

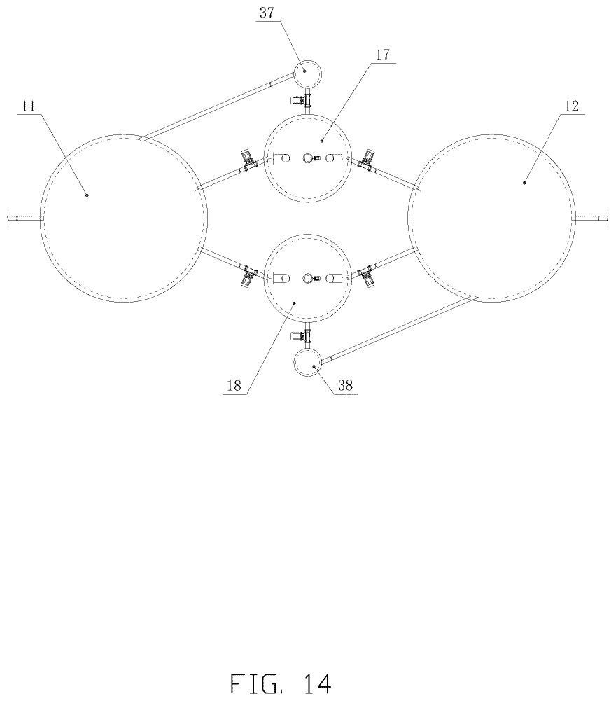

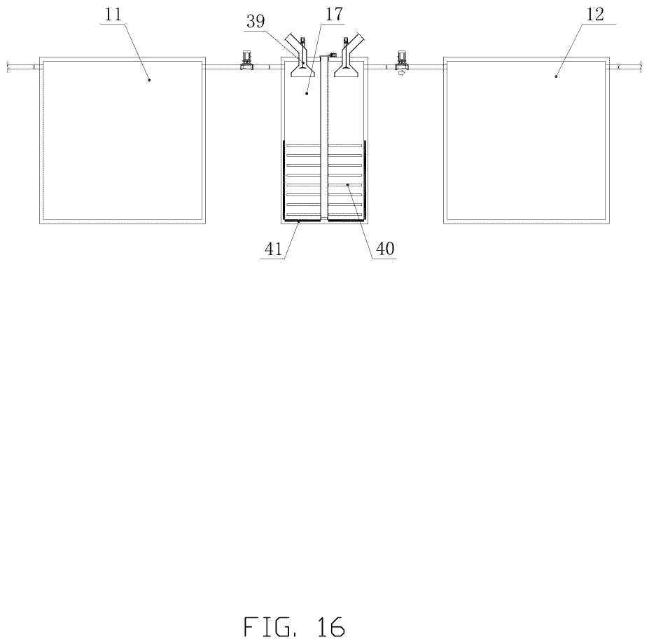

The specific embodiments of the present invention are described in detail below with reference to FIGS. 1 to 16.

As shown in FIGS. 1-16, the present invention utilizes the high solubility and large solubility volume of ammonia gas and hydrogen chloride gas in water to provide a power system that is not constrained by resources or natural conditions. Through this power system, heavy objects are elevated to store energy, and subsequently, the stored potential energy is used to achieve stable power generation. Alternatively, the power system can be used to directly generate electricity or provide mechanical power output.

One aspect of the present invention is a vertically oriented power system and power generation system that is not limited by terrain conditions. A solution is provided at the bottom of the power well, and a piston system is arranged within the well. Highly water-soluble gases such as ammonia or hydrogen chloride are injected into the power well while the piston is lifted. When the piston reaches the upper limit position, the gas pressure inside the power well is maintained at standard atmospheric pressure. A rubber bag isolating the solution from the gas is then opened to allow contact between the gas and the solution. As the gas dissolves into the solution, the internal pressure of the well decreases continuously. Due to the atmospheric pressure acting on the outside of the piston, the piston begins to move downward. During the downward motion, the piston lifts a gravity block from a low position to a high position. When the piston reaches the lower limit of the power well, the gravity block also reaches its highest position. The gravity block is then transferred horizontally to the top of a falling shaft, where it descends by gravity and drives a generator to produce electricity.

By using the dissolution of gas in the solution to generate a pressure difference, the gravity block is elevated to store energy. Then, electricity is generated by the falling motion of the gravity block, thus completing the process of “energy storage and power generation through gas dissolution in liquid.”

A second aspect of the present invention is a power system and power generation system that is inclined and arranged along a slope adjacent to a hillside. The internal structure and working principle of the power well are substantially the same as those of the vertical power system. The difference lies in the arrangement of the power well along the slope according to the terrain. The lifting track of the gravity block is aligned with the power well and arranged along the slope. During the downward movement of the piston in the power well, the gravity block is elevated from the bottom of the slope to the top along the lifting track. The gravity block is then transferred to the upper end of the descending track, which is also slope-aligned like the lifting track. The gravity block slides down the descending track to the bottom of the slope and, in the process, drives a generator to generate electricity.

A third aspect of the present invention is a power system where the power well is arranged horizontally on the ground or in accordance with the ground surface. The internal structure and working principle of the power well are basically the same as those of the vertical power system, except that the power well is laid out horizontally on the ground.

A fourth aspect of the present invention is that the piston in the power well drives a crankshaft through a connecting rod. In this configuration, the up-and-down motion of the piston is converted into torque via the crankshaft, and the torque is output to external systems. This entire process is similar to the operation of an automotive piston engine. For example, four parallel power wells are functionally similar to a four-cylinder in-line engine. The piston power output process operates in two strokes. Taking an ammonia gas-powered well as an example: when the piston is at the top of the power well, gas is injected to maintain one atmosphere of pressure. The rubber bag isolating the solution from the gas is then opened, allowing the gas to contact the solution. As the gas dissolves into the solution, the pressure inside the power well gradually decreases. Subjected to external atmospheric pressure, the piston begins to descend, and through the connecting rod, the downward force is transmitted to the crankshaft, causing it to rotate and generate torque, which is output to external systems. This completes the first stroke.

When the piston reaches the bottom of the power well, the rubber bag is reinflated to isolate the gas from the solution. During the upward stroke of the piston, ammonia gas is injected into the power well while maintaining the internal pressure at one atmosphere. When the piston returns to the top of the well, the second stroke is completed, and a new cycle begins.

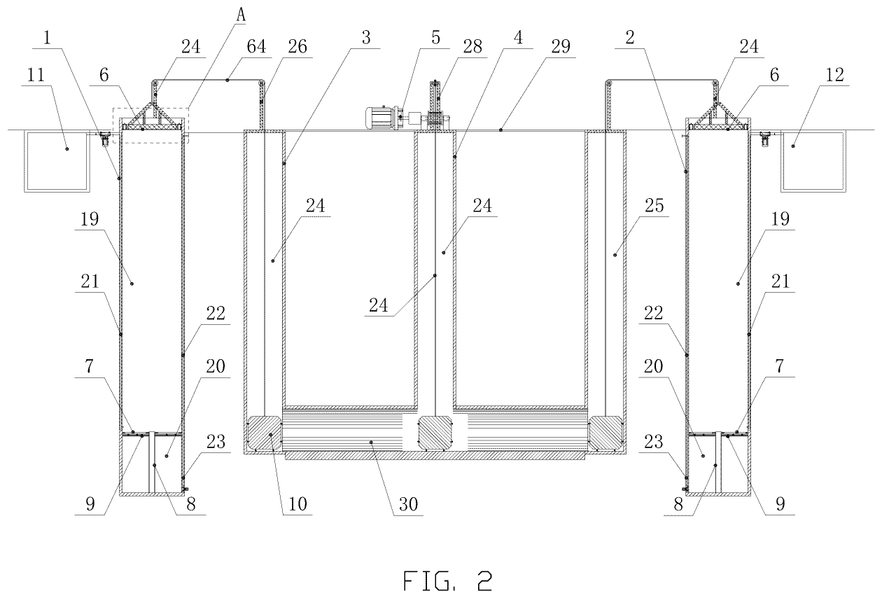

As shown in FIG. 1 in conjunction with FIG. 2, a PISTON-TYPE GAS-POWERED WELL-BASED ENERGY STORAGE AND POWER GENERATION SYSTEM comprises a gas-powered well, a lifting shaft 3, a falling shaft 4, a piston assembly 6, an isolation device 7, power generation equipment 5, and gravity blocks 10.

The interior of the gas-powered well is provided with a sliding chamber 19 for reciprocating movement of the piston assembly 6. A solution tank 20 is provided at the bottom of the sliding chamber 19. The inner wall of the gas-powered well is equipped with mutually independent gas injection pipeline 21, liquid injection pipeline 22, and liquid outlet pipeline 23. The gas injection pipeline 21 is configured to inject gas that is highly soluble in water into the gas-powered well. The outlet of the gas injection pipeline 21 is located at the bottom of the sliding chamber 19. The outlet of the liquid injection pipeline 22 is located at the bottom of the solution tank 20. The inlet of the liquid outlet pipeline 23 is also located at the bottom of the solution tank 20. A first truss beam 24 is arranged at the top of the gas-powered well to support the piston assembly 6. A first pulley is mounted on the first truss beam 24.

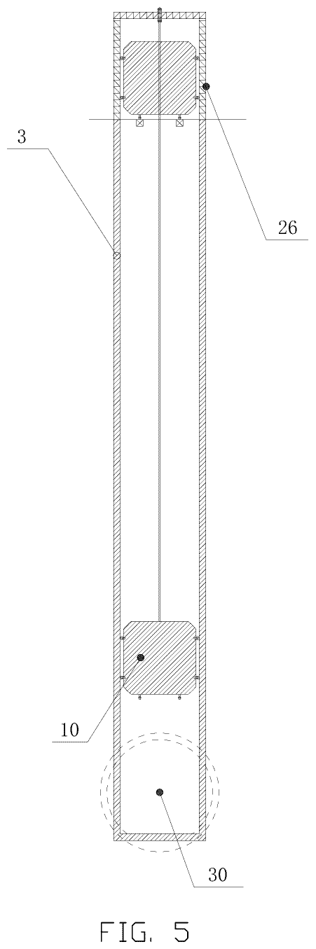

As shown in FIG. 5, an ascending passage 25 for lifting the gravity blocks 10 is provided inside the lifting shaft 3. A second truss beam 26 is arranged at the top of the lifting shaft 3, and a second pulley is mounted on the second truss beam 26.

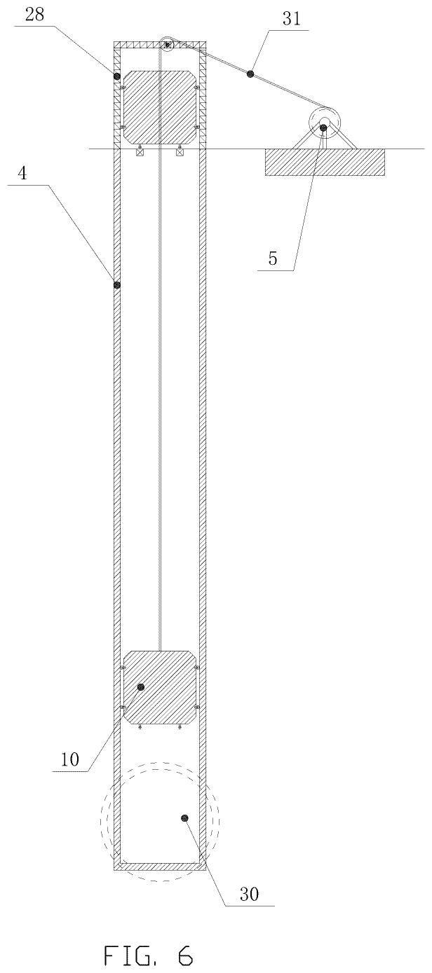

As shown in FIG. 6, a descending passage 27 for the descent of the gravity blocks 10 is provided inside the falling shaft 4. A third truss beam 28 is arranged at the top of the falling shaft 4, and a third pulley is mounted on the third truss beam 28.

As shown in FIG. 2, the top of the lifting shaft 3 is connected to the top of the falling shaft 4 via a track 29. The bottom of the lifting shaft 3 is connected to the bottom of the falling shaft 4 via a tunnel 30, which allows gravity blocks 10 to move from the bottom of the descending passage 27 to the bottom of the ascending passage 25.

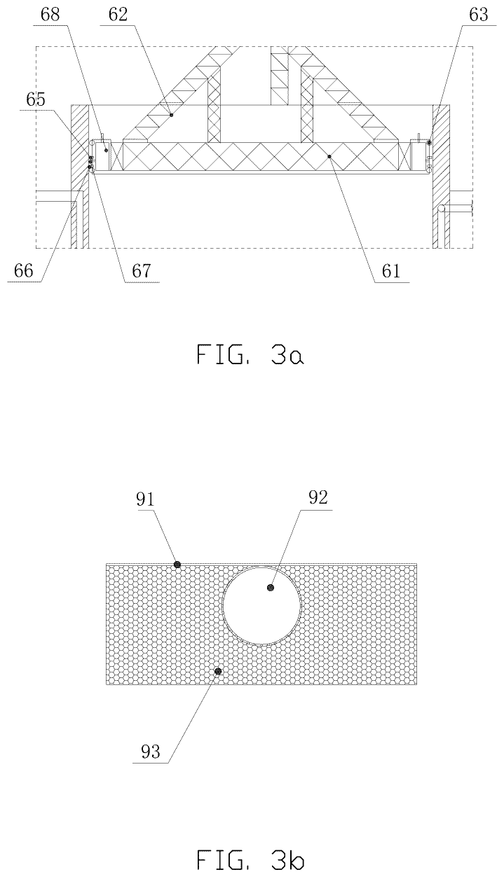

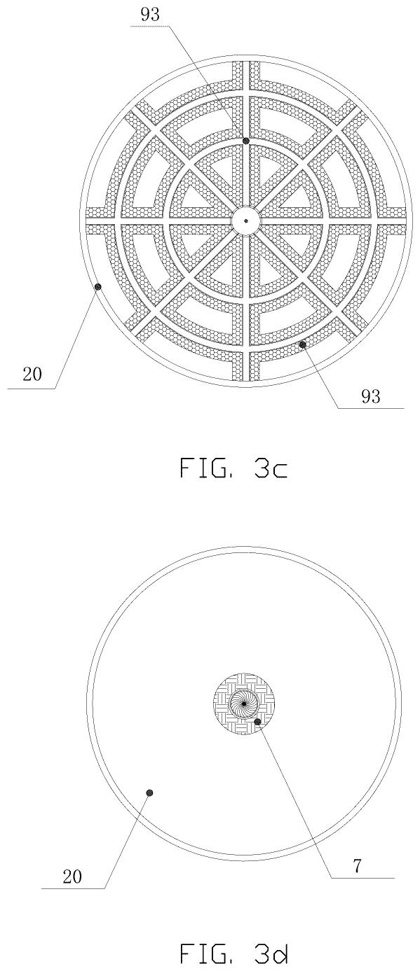

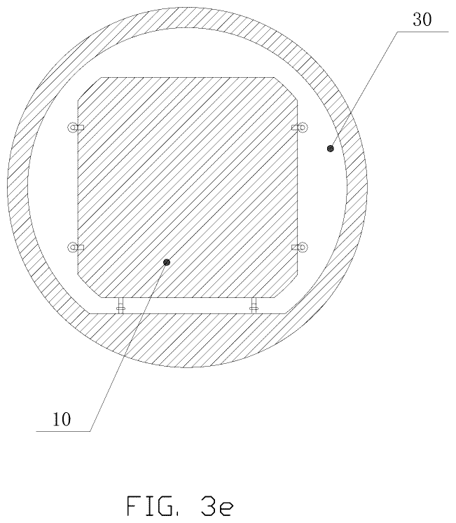

As shown in FIG. 2 in conjunction with FIG. 3a, the piston assembly 6 is disposed within the sliding chamber 19 of the gas-powered well. The piston assembly 6 comprises a piston block 61, a connecting frame 62, support rollers 63, and a connecting rope 64. The support rollers 63 are mounted on the side wall of the piston block 61. The piston block 61 is connected to the inner wall of the sliding chamber 19 via the support rollers 63. A sealing structure is disposed between the side wall of the piston block 61 and the inner wall of the sliding chamber 19, located between a pair of support rollers 63. The connecting frame 62 is fixed to the top of the piston block 61. One end of the connecting rope 64 is fixed to the connecting frame 62. The free end of the connecting rope 64 is connected to the gravity block 10 and extends through the guidance of the first pulley and the second pulley to hang within the lifting shaft 3.

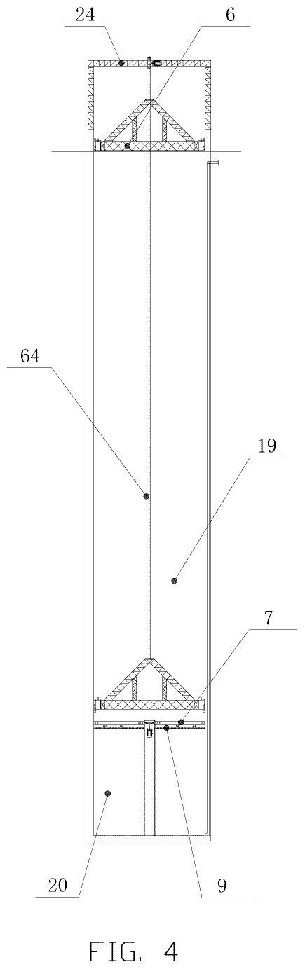

As shown in FIG. 4, the isolation device 7 is positioned between the sliding chamber 19 and the solution tank 20. The isolation device 7 has a telescopic end surface configured to isolate the gas in the sliding chamber 19 from the liquid in the solution tank 20.

As shown in FIG. 2, the power generation equipment 5 is installed above the falling shaft 4. A drum is connected to the output shaft of the power generation equipment 5. A steel wire rope 31 is wound around the drum. One end of the steel wire rope 31 is fixed to the drum, and the connecting end of the steel wire rope 31 is connected to the gravity block 10 and is guided by the third pulley to hang within the falling shaft 4.

As shown in FIG. 3a, the sealing structure comprises a first sealing ring 65 and a second sealing ring 66. Both the first sealing ring 65 and the second sealing ring 66 are sleeved on the side wall of the piston block 61. A watertight cavity 67 for accommodating water is formed between the first sealing ring 65 and the second sealing ring 66.

A water tank 68 for holding water is provided on the piston block 61. The inner wall of the watertight cavity 67 is provided with a communication hole. The bottom of the water tank 68 is connected to the watertight cavity 67 via the communication hole.

As shown in FIG. 2, a ventilation shaft 8 is arranged at the central portion of the solution tank 20. The bottom of the ventilation shaft 8 is fixed to the bottom of the solution tank 20. A fan is provided inside the ventilation shaft 8.

As shown in FIGS. 3b and 3c, a ventilation structure is radially disposed between the ventilation shaft 8 and the solution tank 20. The ventilation structure is located below the isolation device 7 and comprises a gas barrier layer 91, a ventilation pipeline 92, and a sponge layer 93. The gas barrier layer 91 covers the upper side of the sponge layer 93, which is immersed in the liquid within the solution tank 20. The ventilation pipeline is embedded within the sponge layer 93 and is in communication with the side wall of the ventilation shaft 8. A plurality of gas-dispersion holes is formed in the side wall of the ventilation pipeline.

As shown in FIG. 3d, the isolation device 7 comprises an inflatable rubber bag, which is sleeved on the side wall of the ventilation shaft 8. The inflatable rubber bag expands and contracts radially in response to control by an air pump.

As shown in FIG. 1, the gas-powered well includes an ammonia gas-powered well 1 and a hydrogen chloride gas-powered well 2. A first lifting shaft 3 is arranged corresponding to the ammonia gas-powered well 1, and a second lifting shaft 3 is arranged corresponding to the hydrogen chloride gas-powered well 2. The falling shaft 4 is located between the first lifting shaft 3 and the second lifting shaft 3.

The top of the first lifting shaft 3 is connected to the top of the falling shaft 4 by a track 29, and the bottom of the first lifting shaft 3 is connected to the bottom of the falling shaft 4 by a tunnel 30.

Similarly, the top of the second lifting shaft 3 is connected to the top of the falling shaft 4 by a track 29, and the bottom of the second lifting shaft 3 is also connected to the bottom of the falling shaft 4 by the tunnel 30.

An ammonia storage tank 11 is provided on one side of the ammonia gas-powered well 1. The ammonia storage tank 11 is connected to the gas injection pipeline 21 of the ammonia gas-powered well 1 via a pipeline.

Likewise, a hydrogen chloride gas storage tank 12 is provided on one side of the hydrogen chloride gas-powered well 2. The hydrogen chloride gas storage tank 12 is connected to the gas injection pipeline 21 of the hydrogen chloride gas-powered well 2 via a pipeline.

As shown in FIGS. 1, 2, and 14-16, an ammonium chloride solution storage tank 13 is arranged between the ammonia gas-powered well 1 and the hydrogen chloride gas-powered well 2. The ammonium chloride solution storage tank 13 is connected via pipelines to deliver ammonium chloride solution to the liquid injection pipelines 22 of both the ammonia gas-powered well 1 and the hydrogen chloride gas-powered well 2.

An ammonium chloride solution tank 14 containing ammonia water is provided on one side of the ammonia gas-powered well 1. The tank 14 is connected to the liquid outlet pipeline 23 of the ammonia gas-powered well 1 via a pipeline.

A separate ammonium chloride solution tank 15 containing hydrochloric acid is provided on one side of the hydrogen chloride gas-powered well 2. The tank 15 is connected to the liquid outlet pipeline 23 of the hydrogen chloride gas-powered well 2 via a pipeline.

A mixing tank 16 is provided between the ammonium chloride solution tank 14 containing ammonia water and the ammonium chloride solution tank 15 containing hydrochloric acid. The ammonia-water tank 14 is connected to the mixing tank 16 via a pipeline, and the hydrochloric acid tank 15 is also connected to the mixing tank 16 via another pipeline. The mixing tank 16 is connected via a pipeline to the ammonium chloride solution storage tank 13.

A reaction tank is arranged between the ammonia gas-powered well 1 and the hydrogen chloride gas-powered well 2. The reaction tank is connected to the ammonia storage tank 11 and the hydrogen chloride storage tank 12 via pipelines. The reaction tank, ammonia storage tank 11, and hydrogen chloride storage tank 12 together form a regeneration system for ammonia gas and hydrogen chloride gas.

Preferably, the gas-powered wells, the lifting shafts 3, and the falling shaft 4 are all embedded below the ground surface.

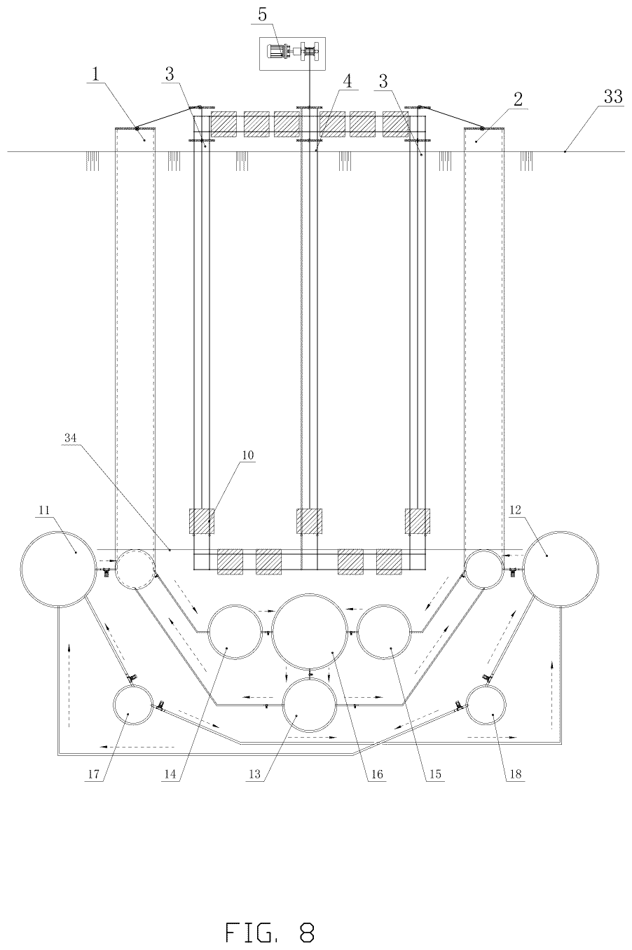

As shown in FIG. 8, the gas-powered well, the lifting shaft (lifting track) 3, and the falling shaft (descending track) 4 are all constructed along the slope of a mountain. The power generation equipment 5 is located at the top of the mountain slope.

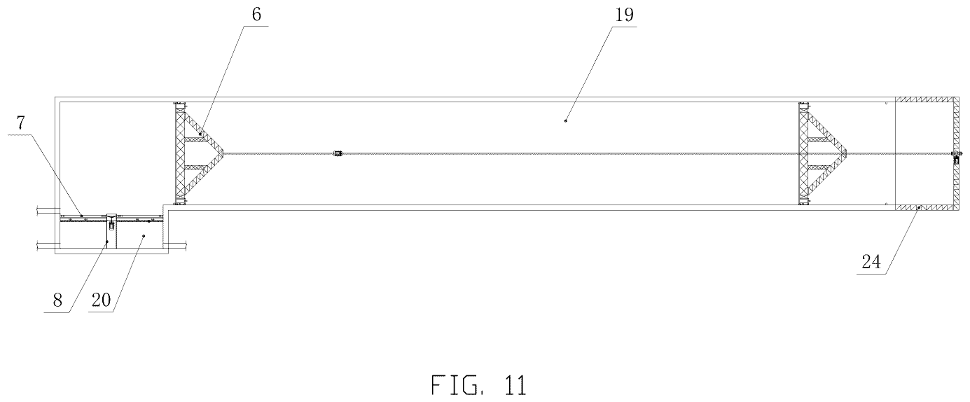

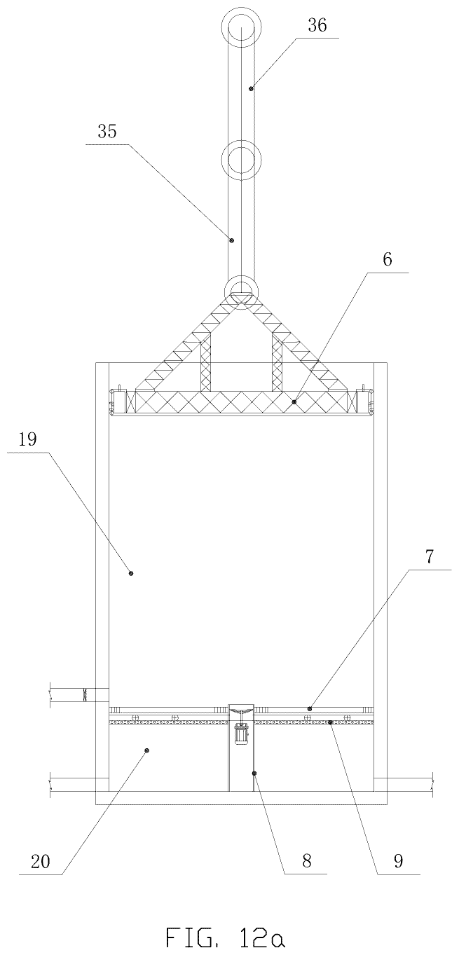

As shown in FIG. 11, an embodiment of the present invention further provides a PISTON-TYPE GAS-POWERED WELL-BASED ENERGY STORAGE AND POWER GENERATION SYSTEM, which comprises a gas-powered well, a piston assembly 6, an isolation device 7, and power generation equipment 5.

The gas-powered well is arranged horizontally in the axial direction. The interior of the gas-powered well comprises a sliding chamber 19 for the reciprocating movement of the piston assembly 6. A solution tank 20 is arranged on one side of the sliding chamber 19, forming an L-shaped structure with the chamber. A truss column is provided on the opposite side of the gas-powered well to provide traction to the piston assembly 6, and a steering pulley is mounted on the truss column.

The wall of the gas-powered well is provided with independent gas injection pipeline 21, liquid injection pipeline 22, and liquid outlet pipeline 23. The gas injection pipeline 21 is used to inject gas that is highly soluble in water into the gas-powered well. The outlet of the gas injection pipeline 21 is located inside the sliding chamber 19. The outlet of the liquid injection pipeline 22 is located at the bottom of the solution tank 20. The inlet of the liquid outlet pipeline 23 is also located at the bottom of the solution tank 20.

The power generation equipment 5 is mounted on the truss column, and a drum is connected to the output shaft of the power generation equipment 5.

The piston assembly 6 is positioned within the sliding chamber 19 of the gas-powered well. The piston assembly 6 comprises a piston block 61, a connecting frame 62, support rollers 63, and a connecting rope 64. The support rollers 63 are mounted on the side wall of the piston block 61. The piston block 61 is connected to the inner wall of the sliding chamber 19 via the support rollers 63. A sealing structure is arranged between the side wall of the piston block 61 and the inner wall of the sliding chamber 19, and the sealing structure is located between a pair of support rollers 63. The connecting frame 62 is fixed on the top of the piston block 61. One end of the connecting rope 64 is fixed to the connecting frame 62, and the other end of the connecting rope 64 is guided by the steering pulley and wound around the drum.

The isolation device 7 is disposed between the sliding chamber 19 and the solution tank 20. The isolation device 7 includes a telescopic end surface for preventing the gas in the sliding chamber 19 from coming into contact with the liquid in the solution tank 20.

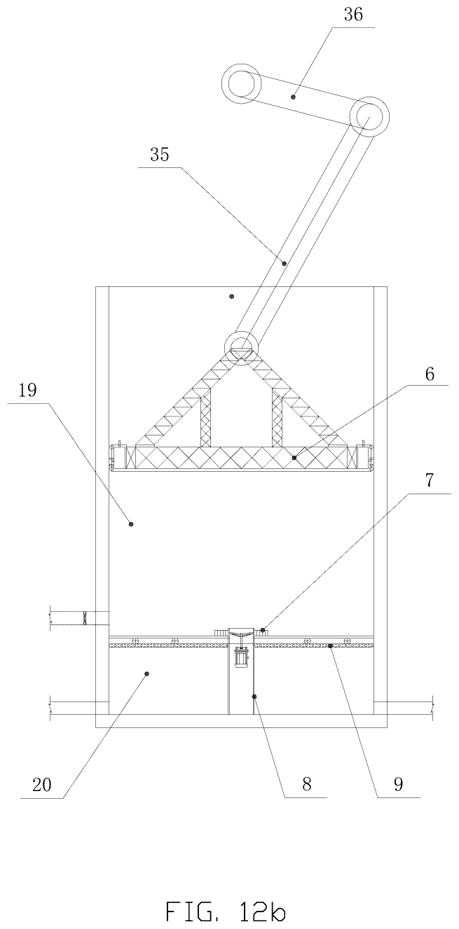

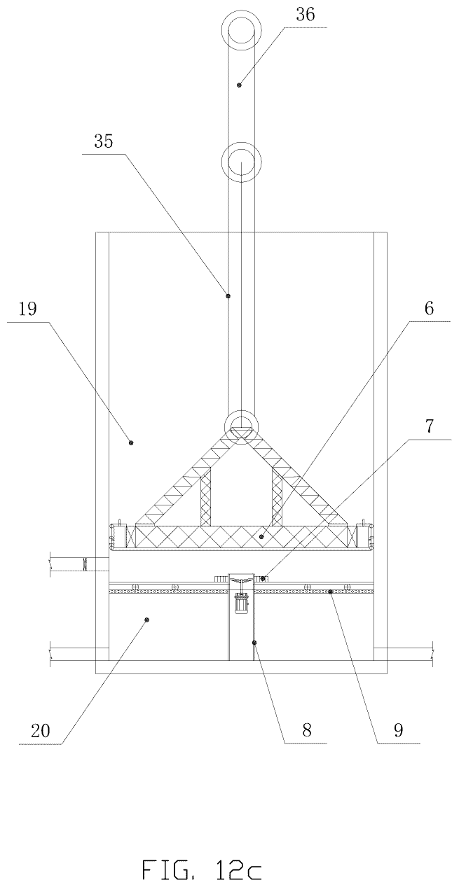

As shown in FIGS. 12a-12c, the present invention further provides a PISTON-TYPE GAS-POWERED WELL-BASED ENERGY STORAGE AND POWER GENERATION SYSTEM, comprising a gas-powered well, a piston assembly 6, an isolation device 7, a connecting rod 35, a crankshaft 36, and power generation equipment 5.

The interior of the gas-powered well comprises a sliding chamber 19 for reciprocating motion of the piston assembly 6. A solution tank 20 is provided at the bottom of the sliding chamber 19. The wall of the gas-powered well is provided with independent gas injection pipeline 21, liquid injection pipeline 22, and liquid outlet pipeline 23. The gas injection pipeline 21 is used to inject gas that is highly soluble in water into the gas-powered well. The outlet of the gas injection pipeline 21 is located at the bottom of the sliding chamber 19. The outlet of the liquid injection pipeline 22 is located at the bottom of the solution tank 20. The inlet of the liquid outlet pipeline 23 is also located at the bottom of the solution tank 20.

The piston assembly 6 is disposed within the sliding chamber 19 of the gas-powered well. The piston assembly 6 comprises a piston block 61, a connecting frame 62, support rollers 63, a connecting rod 35, and a crankshaft 36. The support rollers 63 are mounted on the side wall of the piston block 61. The piston block 61 is connected to the inner wall of the sliding chamber 19 via the support rollers 63. A sealing structure is arranged between the side wall of the piston block 61 and the inner wall of the sliding chamber 19, and the sealing structure is located between a pair of support rollers 63. The connecting frame 62 is fixed at the top of the piston block 61 and is connected to the crankshaft 36 via the connecting rod 35.

The isolation device 7 is located between the sliding chamber 19 and the solution tank 20 and includes a telescopic end surface to isolate the gas in the sliding chamber 19 from the liquid in the solution tank 20.

The output shaft of the power generation equipment 5 is connected to one end of the crankshaft 36.

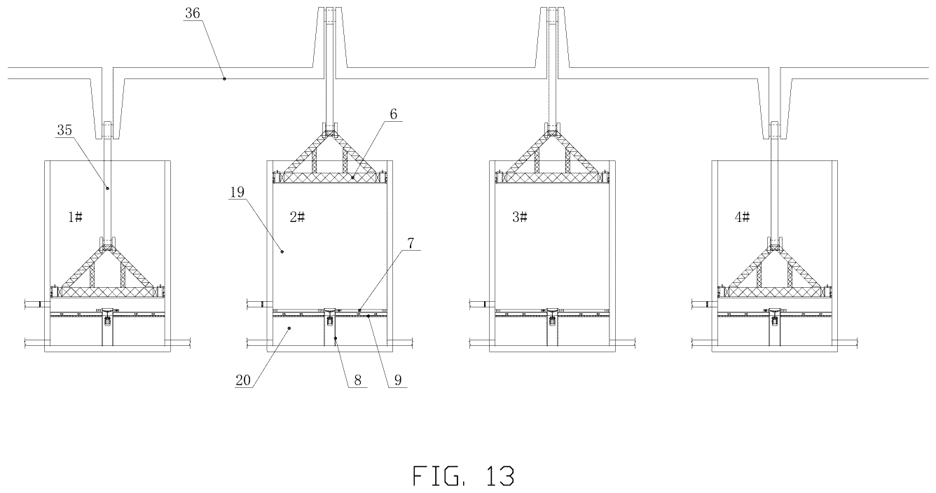

As shown in FIG. 13, a plurality of gas-powered wells are linearly arranged along the axial direction of the crankshaft 36. The connecting frame 62 of each piston assembly 6 within each gas-powered well is connected to the crankshaft 36 via a connecting rod 35.

### Vertical Underground Ammonia Gas-Powered Well System

The vertical underground ammonia gas-powered well system comprises a wellbore, a bottom solution tank, a surface aeration-assisted dissolution fan shaft, surface aeration-assisted dissolution pipelines, a surface isolation rubber bag, a piston, an upper truss column of the power well, a truss beam, pulleys, an electric motor, an ammonia gas injection pipe, a water inlet pipe, and a water outlet pipe.

### (1) Wellbore

The wellbore adopts a circular structure with favorable stress-bearing characteristics. The structural material is reinforced concrete, and the inner surface is lined with corrosion-resistant materials such as fiberglass, stainless steel, or resin that are resistant to ammonium chloride solution, ammonia solution, hydrochloric acid, ammonia gas, and hydrogen chloride gas.

At the lower part of the wellbore, a piston limit block is installed on the well wall at the designed lowest position of piston movement to prevent further downward travel.

### (2) Bottom Solution Tank

A certain depth of ammonium chloride solution is arranged at the bottom of the power well, forming a solution tank at the bottom of the wellbore.

### (3) Surface Aeration-Assisted Dissolution Fan Shaft

At the center of the wellbore bottom plate, a fan facility is provided to accelerate the dissolution of gas into the solution. A steel pipe is installed through the wellbore bottom plate and extends above the solution surface. An electric motor is installed inside the pipe to drive a fan located at the upper part, which blows gas into the aeration pipes on the surface of the solution.

A gas baffle plate is arranged between the electric motor and the fan, and at the bottom of the aeration pipe, to redirect the airflow by 90 degrees into the various aeration pipelines. The motor's power cable conduit may be pre-embedded into the concrete at the edge and side walls of the wellbore base.

### (4) Surface Aeration-Assisted Dissolution Pipelines

Centered on the fan shaft, radial aeration pipelines are arranged every 45 degrees, each connected to the fan shaft. Two annular aeration pipes are arranged on the radial pipes to connect their distal and mid sections, promoting internal gas circulation within the aeration-assisted pipelines.

Each aeration pipe is wrapped in perforated sponge foam. Multiple gas-dispersion holes are provided at the upper and lower portions of the aeration pipe, allowing gas from inside the pipe to disperse rapidly into the sponge foam. The gas fully contacts the water through the foam and dissolves into the solution.

### (5) Surface Isolation Rubber Bag

At the solution surface, a circular rubber bag is provided and fixed to the outer wall of the fan shaft. When inflated, the rubber bag expands and covers the entire liquid surface to isolate it from the ammonia gas inside the power well, thereby preventing the ammonia gas from contacting and dissolving into the ammonium chloride solution.

When it is necessary to dissolve ammonia gas into the solution, the gas inside the rubber bag is evacuated, and the rubber bag contracts toward the wall of the fan shaft, thereby exposing the solution surface.

### (6) Piston

The piston is a vertically movable component within the wellbore that moves up and down in response to changes in internal gas pressure, similar in function to the piston in an internal combustion engine.

To reduce the piston's self-weight and improve its overall rigidity, the piston adopts a lightweight steel planar and vertical truss structure. The piston is circular in shape, and a layer of stainless steel plate is provided at the bottom of the planar truss to isolate it from external air.

The contact portion between the piston and the wellbore comprises a rigid sidewall of a certain height. Rollers are mounted at the upper and lower ends of the sidewall, which provide support between the piston and the well wall and reduce friction during piston movement.

Between the upper and lower rollers on the piston sidewall, two gas-sealing rings are arranged, analogous to the gas and oil rings in an internal combustion engine piston. A water tank is arranged on the inner side of the piston sidewall, filled with water, and provided with a refill opening at the top. When the water level is low, water can be refilled via the refill port.

A communicating pipe is arranged between the water tank and the two gas-sealing rings, allowing the space between the two sealing rings to be filled with water, thereby forming a water seal. During piston movement, the water seal effectively isolates the ammonia gas inside the well from the external atmosphere and prevents gas leakage. It also provides lubrication, reducing friction between the piston rings and the well wall.

A wire rope coupling is arranged at the top of the vertical truss of the piston for connecting the wire rope above.

### (7) Upper Truss Column, Truss Beam, Pulley, and Electric Motor of the Power Well

An upper truss column and a truss beam are arranged at the top of the power well. The truss beam is supported on the truss columns.

A pulley is mounted on the truss beam, and the wire rope is routed over the pulley. A small electric motor is connected to the pulley. During the injection of ammonia gas into the power well, the motor drives the pulley to lift the piston, synchronizing piston elevation with the gas injection process. Once the internal pressure of the power well reaches one atmosphere, the piston is elevated to its upper limit. When the piston descends, the pulley is disconnected from the motor.

### (8) Ammonia Gas Injection Pipe

The ammonia gas injection pipe is embedded within the wall of the well. The lower end outlet is located between the rubber isolation bag and the piston limit block, and the upper end is connected to the ammonia storage tank. A valve is provided on the pipeline near the ammonia storage tank. The valve is closed when ammonia injection is not needed.

### (9) Water Inlet Pipe

The water inlet pipe is embedded within the wall of the well. The lower inlet is located at the bottom end of the well wall, and the upper end is connected to the “ammonium chloride solution storage tank.” A pump and valve are installed at the upper end of the pipeline. When solution needs to be added to the power well, the pump and valve are turned on.

### (10) Water Outlet Pipe

The water outlet pipe is also embedded within the wall of the well. The lower outlet is located at the bottom end of the well wall, and the upper end is connected to the “ammonia-containing ammonium chloride solution tank.” A pump and valve are arranged at the lower end of the pipeline. When the solution needs to be extracted from the power well to the solution tank, the pump and valve are activated.

### Vertical Underground Hydrogen Chloride Gas-Powered Well System

The vertical underground hydrogen chloride gas-powered well system shares the same structure as the vertical underground ammonia gas-powered well system, with the following differences:

### (1) Hydrogen Chloride Gas Injection

Hydrogen chloride gas is injected into the power well. The hydrogen chloride gas injection pipe is embedded within the wall of the well. The lower outlet of the pipe is positioned between the rubber isolation bag and the piston limit block, and the upper end is connected to the hydrogen chloride gas storage tank. A valve is installed in the pipeline at the hydrogen chloride gas storage tank. When gas injection is not required, the valve is closed.

### (2) Water Inlet Pipe

The water inlet pipe is embedded within the well wall. The lower inlet is located at the bottom of the well wall, and the upper end is connected to the ammonium chloride solution storage tank. A water pump and valve are installed at the upper end of the pipe. When it is necessary to inject solution into the power well, the pump and valve are turned on.

### (3) Water Outlet Pipe

The water outlet pipe is also embedded in the wall of the well. The lower outlet is located at the bottom of the well wall, and the upper end is connected to the hydrochloric acid-containing ammonium chloride solution tank. A pump and valve are installed at the lower end of the pipeline. When the solution in the power well needs to be extracted into the hydrochloric acid-containing ammonium chloride solution tank, the pump and valve are turned on.

### Gravity Block System

The gravity block is the medium used to store energy through elevation within the power well and to generate electricity through gravitational descent.

The gravity block is made of reinforced concrete or consists of a steel shell filled with concrete. Two pairs of wheels are provided at the bottom of the gravity block. The wheels are in the form of train wheels and are fixed to the gravity block via supporting brackets.

On each of the four vertical faces of the gravity block, one upper and one lower positioning roller are arranged. During lifting and falling, the rollers serve as position-limit devices within the shaft to prevent the gravity block from swinging. These rollers also reduce friction between the block and the shaft wall during movement.

A lifting ring is provided at the center of the top surface of the gravity block.

The base of the lifting ring is fixed within the gravity block and is connected to a steel wire rope.

### Underground Gravity Block Lifting Shaft System

The gravity block lifting shaft is arranged in parallel with the power well. The gravity block is positioned at the bottom of the lifting shaft. The top of the vertical truss of the piston in the power well is connected to the lifting ring at the top of the gravity block via a steel wire rope. The steel wire rope passes over pulleys located at the tops of both the power well and the gravity block lifting shaft.

The gravity block lifting shaft is constructed of reinforced concrete. Its internal shape and dimensions are slightly larger than those of the gravity block to maintain a clearance between the shaft wall and the positioning rollers of the gravity block.

The bottom of the gravity block lifting shaft is connected to the bottom of the gravity block falling shaft via a tunnel.

A portal truss is arranged at the top of the lifting shaft, with a pulley provided at its center. The steel wire rope passes over this pulley and connects to the pulley located on the truss at the top of the power well.

A movable and openable track is arranged at the top of the lifting shaft. During the lifting process, the track is positioned laterally alongside the shaft. When the gravity block is lifted above the shaft opening, the track moves into place above the shaft opening and aligns with the wheels at the bottom of the gravity block. At this point, the gravity block descends slightly, and the wheels rest on the track.

The track is aligned with a ground-level track located on the right side of the lifting shaft. The gravity block moves along the track to the upper portion of the gravity block falling shaft.

### Underground Gravity Block Falling Shaft System

The gravity block falling shaft is arranged in parallel with the gravity block lifting shaft.

The gravity block is placed on a track at the top of the falling shaft.

The falling shaft is constructed of reinforced concrete. Its internal shape and dimensions are slightly larger than those of the gravity block to maintain a small gap between the shaft wall and the positioning rollers of the gravity block.

The bottom of the falling shaft is connected to the bottom of the lifting shaft via a tunnel.

A portal truss is arranged at the top of the falling shaft. A pulley is arranged at the center of the truss. The steel wire rope is connected to the lifting ring on top of the gravity block, passes over the central pulley of the truss, and is further routed to a winding drum of the generator system.

A movable and openable track is also arranged at the top of the falling shaft. Before the gravity block begins to fall, the track is removed to allow the gravity block to descend along the shaft.

As the gravity block falls down the shaft, the steel wire rope wound around the generator's drum drives the generator to rotate and generate electricity.

### Tunnel Connection System

The gravity block lifting shaft and the gravity block falling shaft are connected at the bottom via a tunnel. A track is laid on the floor of the tunnel. The gravity block located at the bottom of the gravity block falling shaft moves through the tunnel and along the track to the bottom of the gravity block lifting shaft.

The complete operating cycle is as follows:

The gravity block is initially located at the bottom of the gravity block lifting shaft [symbol] it is lifted to the shaft opening [symbol] transferred along a ground-level track to the opening of the gravity block falling shaft [symbol] descends to the bottom of the falling shaft [symbol] returns through the tunnel to the lifting shaft bottom, completing one cycle.

### Power Generation System

The power generation system is located on the side of the gravity block falling shaft. During the descent of the gravity block, a steel wire rope wound around a drum in the power generation system drives the generator to rotate and produce electricity.

The power generation system comprises a foundation, a steel wire rope drum, a speed-reduction gearbox, and a generator.

### Rail Transport System

The gravity block lifting shaft and falling shaft associated with the ammonia gas-powered well, and the gravity block lifting shaft associated with the hydrogen chloride gas-powered well, are connected via a track system.

On the ground level, these shafts are connected by ground-installed tracks. Underground, they are connected via tracks laid on the floor of the tunnel. The top ends of the lifting shafts and falling shafts are provided with openable and closable tracks. The track system uses railway-grade steel tracks.

The gravity blocks circulate continuously through the system via the track transport infrastructure.

### Ammonia Gas Storage System

An ammonia gas storage tank is provided adjacent to the ammonia gas-powered well. The tank is a prefabricated steel container lined with corrosion-resistant materials such as fiberglass, stainless steel, or resin to prevent damage from ammonia and hydrogen chloride gases.

The ammonia storage tank holds a volume of ammonia gas equal to approximately 2-3 times the amount required for one operational cycle of the ammonia gas-powered well. The tank maintains an internal pressure of 1-2 times standard atmospheric pressure to ensure a stable and reliable supply of ammonia gas to the well.

The ammonia and hydrogen chloride gas regeneration system is connected to the ammonia storage tank via pipelines to intermittently or continuously replenish the tank with regenerated ammonia gas.

### Hydrogen Chloride Gas Storage System

A hydrogen chloride gas storage tank is arranged adjacent to the hydrogen chloride gas-powered well. This tank is also a prefabricated steel container lined with corrosion-resistant materials such as fiberglass, stainless steel, or resin.

The tank stores hydrogen chloride gas in a quantity equivalent to 2-3 times the amount required for one operational cycle of the hydrogen chloride gas-powered well. The tank operates at a pressure of 1-2 times atmospheric pressure to ensure a stable and reliable gas supply.

The ammonia and hydrogen chloride gas regeneration system is connected to the hydrogen chloride gas storage tank via pipelines to intermittently or continuously replenish the tank with regenerated hydrogen chloride gas.

### Ammonia-Containing Ammonium Chloride Solution Tank System

The solution tank adopts a circular structure with superior mechanical strength and is constructed from reinforced concrete. Its inner surface is lined with fiberglass, stainless steel, or resin materials that are resistant to corrosion caused by ammonium chloride solution, ammonia solution, hydrochloric acid, ammonia gas, and hydrogen chloride gas.

The solution tank is a sealed structure to prevent the leakage of volatilized gases.

The inlet of the solution tank is connected to the outlet pipe of the ammonia gas-powered well. Ammonium chloride solution, enriched with ammonia and extracted from the bottom solution tank of the ammonia gas-powered well, is injected into the solution tank.

The outlet of the solution tank is connected via pipeline to the Ammonia-Containing Ammonium Chloride Solution Tank and to the Mixed Solution Tank for Ammonia-Containing and Hydrogen Chloride-Containing Solutions (Ammonium Chloride Solution Tank/Crystallization Precipitation Tank).

### Hydrochloric Acid-Containing Ammonium Chloride Solution Tank System

The structure of this solution tank is identical to the ammonia-containing solution tank: circular, reinforced concrete with a corrosion-resistant inner lining (e.g., fiberglass, stainless steel, resin) to protect against ammonium chloride solution, ammonia solution, hydrochloric acid, ammonia gas, and hydrogen chloride gas.

The tank is fully enclosed to prevent leakage of volatilized gas.

The inlet of the tank connects to the outlet pipe of the hydrogen chloride gas-powered well. Ammonium chloride solution, enriched with hydrochloric acid and extracted from the bottom of the hydrogen chloride gas-powered well, is injected into this tank.

The outlet is connected via pipeline to the Hydrochloric Acid-Containing Ammonium Chloride Solution Tank and to the Mixed Solution Tank for Ammonia-Containing and Hydrogen Chloride-Containing Solutions (Ammonium Chloride Solution Tank/Crystallization Precipitation Tank).

Mixed Solution Tank for Ammonia-Containing and Hydrogen Chloride-Containing Solutions

### (Ammonium Chloride Solution Tank/Crystallization Precipitation Tank)

The mixing tank adopts a funnel shape and is constructed with a reinforced concrete structure. The inner surface is lined with fiberglass, stainless steel, or resin, resistant to corrosion from ammonium chloride solution, ammonia solution, hydrochloric acid, ammonia gas, and hydrogen chloride gas.

Solutions from the Ammonia-Containing Ammonium Chloride Solution Tank (left side) and the Hydrochloric Acid-Containing Ammonium Chloride Solution Tank (right side) are fed into the mixing tank via pipelines. The inflow ratio corresponds to the stoichiometric reaction ratio between ammonia and hydrochloric acid.

A chemical reaction takes place within the mixing tank, producing a supersaturated ammonium chloride solution. Crystals of ammonium chloride precipitate and settle at the bottom of the funnel.

At the funnel's outlet, an upward-opening flap gate is installed. It remains open under normal conditions. Once the precipitated ammonium chloride fills the centrifuge drum, the flap gate closes.

An electric motor drives a gear mechanism that engages with the gear ring of the centrifuge drum, rotating the drum. The ammonium chloride solution is expelled to the outer ammonium chloride recovery tank via centrifugal force, while the dehydrated solid ammonium chloride remains in the drum.

After the dehydration process is completed, a downward-opening flap gate at the bottom of the centrifuge drum is opened to discharge the solid ammonium chloride into an ammonium chloride collection cart below.

During the dehydration process, the recovered ammonium chloride solution in the outer tank is returned to the upper mixing tank through a pipeline and pipeline pump.

### Ammonium Chloride Solution Storage Tank System

The Ammonium Chloride Solution Storage Tank also adopts a circular structure with high mechanical strength, constructed from reinforced concrete. The inner surface is lined with fiberglass, stainless steel, or resin, resistant to corrosion caused by ammonium chloride solution, ammonia solution, hydrochloric acid, ammonia gas, and hydrogen chloride gas.

After precipitation and filtration of the ammonium chloride crystals in the Mixed Solution Tank (Ammonium Chloride Solution Tank/Crystallization Precipitation Tank), the purified saturated ammonium chloride solution is injected into the Ammonium Chloride Solution Storage Tank through a pipeline.

The outlet pipe of the Ammonium Chloride Solution Storage Tank is connected to the inlet pipes of both the ammonia gas-powered well and the hydrogen chloride gas-powered well.

Hillside Ammonia Gas-Powered and Hydrogen Chloride Gas-Powered Well Systems

In mountainous terrain, the ammonia (or hydrogen chloride) gas-powered well system can be constructed as a hillside system, built along the slope of the mountain to reduce construction costs.

The overall structure of the hillside ammonia (or hydrogen chloride) gas-powered well system is similar to that of the underground vertical system. The key differences are:

The bottom solution tank is arranged horizontally.

The power well is constructed at an incline along the mountain slope.

A bend section is provided between the solution tank and the inclined power well, corresponding to the slope angle.

The auxiliary units including the ammonia gas storage tank, ammonia-containing ammonium chloride solution tank, mixed solution tank for ammonia and hydrogen chloride (ammonium chloride solution tank/crystallization precipitation tank), hydrochloric acid-containing ammonium chloride solution tank, and ammonium chloride solution storage tank are all installed at the base of the slope on a relatively flat platform.

### Hillside Gravity Block Lifting Rail System

The hillside gravity block lifting system lifts the gravity block from the base of the slope to the top.

A track is laid along the slope. At the top end of the track (slope top), a portal truss is erected, with a pulley installed at the top of the truss. A steel wire rope connected to the piston in the power well passes over this pulley and is connected to the lifting ring at the top of the gravity block.

As the piston in the power well moves downward, the gravity block is lifted along the sloped track from the base to the top of the hill.

### Hillside Gravity Block Descent Rail System

The hillside gravity block descent rail system allows the gravity block to descend from the top of the slope to the base.

A track is laid along the slope. At the top end of the track (slope top), a portal truss is installed, with a pulley mounted at the top. One end of the steel wire rope is connected to the lifting ring on the gravity block. The rope is routed over the pulley on the portal truss and then wound onto the drum of the generator system.

As the gravity block slides down along the sloped rail, the steel wire rope drives the generator drum to rotate, thereby generating electricity.

### Hillside Base Platform Rail System

The base platform rail connects the bottom ends of the gravity block lifting rail and the descent rail at the base of the slope. This platform is positioned perpendicularly to the two sloped rails.

At the junctions between the base platform rail and the lifting/descent rails, a 90-degree rotatable rail switching system is installed. When the gravity block reaches the junction, the switching system rotates the track section by 90 degrees to align and connect with either the lifting or descent rail.

### Hillside Top Platform Rail System

The top platform rail connects the top ends of the gravity block lifting rail and the descent rail at the top of the slope. This platform is also laid perpendicular to the sloped rails.

A 90-degree rotatable rail switching system is installed at the junctions between the top platform rail and the lifting/descent rails. When the gravity block reaches the junction, the switching system rotates the track section by 90 degrees to connect with the desired rail for subsequent movement.

### Horizontal Ammonia (Hydrogen Chloride) Gas-Powered Well System

The ammonia (or hydrogen chloride) gas-powered well can also be constructed in a horizontal configuration, which further reduces construction costs.

The overall structure of the horizontal ammonia (or hydrogen chloride) gas-powered well system is similar to that of the vertical underground version. The primary difference lies in the layout:

The bottom solution tank is oriented perpendicular to the ground.

The power well is oriented parallel to the ground.

The solution tank and the power well form a 90-degree angle with each other.

The associated units—including the ammonia gas storage tank, ammonia-containing ammonium chloride solution tank, mixed solution tank for ammonia and hydrogen chloride solutions (ammonium chloride solution/crystallization precipitation tank), hydrochloric acid-containing ammonium chloride solution tank, and ammonium chloride solution storage tank—are all arranged above ground.

### Crankshaft-Driven Power Well System

The crankshaft-driven power well system comprises a well casing, bottom solution tank, surface aeration fan shaft, aeration solution pipes, surface isolation rubber bag, piston, connecting rod, crankshaft, ammonia gas injection pipe, water inlet pipe, and water outlet pipe.

The well casing, solution tank, fan shaft, aeration pipes, isolation rubber bag, piston, ammonia injection pipe, and water inlet/outlet pipes are identical or similar in structure to those in the vertical ammonia (or hydrogen chloride) gas-powered well system.

### (1) Connecting Rod

One end of the connecting rod is connected to the bearing at the top of the vertical truss of the piston; the other end is connected to the crankshaft.

### (2) Crankshaft

The crankshaft is connected to the piston via the connecting rod. As the piston drives the connecting rod up and down, the crankshaft rotates around a fixed axis. The vertical reciprocating motion of the piston is thus converted into rotational torque, which can be transferred to an external load.

### (3) Parallel Power Wells

Multiple power wells may be connected in parallel on a single crankshaft-similar to the configuration of an internal combustion engine. For example, four parallel power wells are functionally analogous to a 4-cylinder inline engine.

### Ammonia and Hydrogen Chloride Gas Regeneration System

The ammonia and hydrogen chloride gas regeneration system comprises a reaction tank, an ammonia gas storage tank, and a hydrogen chloride gas storage tank.

Ammonium chloride solids collected from the ammonium chloride crystallization precipitation tank are delivered to the reaction tank, where they undergo chemical reactions to generate ammonia gas and hydrogen chloride gas.

In the reaction tank, ammonium chloride reacts with sulfuric acid to produce ammonium bisulfate and hydrogen chloride gas. The generated hydrogen chloride gas is extracted through a pipeline by a gas pump and stored in the hydrogen chloride gas storage tank.

After the reaction between ammonium chloride and sulfuric acid is complete, all generated hydrogen chloride gas is evacuated and transferred to the hydrogen chloride gas storage tank.

Next, the ammonium bisulfate remaining in the tank is heated, causing it to decompose into sulfuric acid and ammonia gas. The generated ammonia gas is then drawn through a pipeline and stored in the ammonia gas storage tank. Once the decomposition is complete, and all ammonia gas is evacuated to the storage tank, only sulfuric acid remains in the reaction tank, completing one full regeneration cycle.

### (1) Reaction Tank

The reaction tank is a cylindrical steel container lined with fiberglass, stainless steel, or resin, which resists corrosion from ammonia gas, hydrogen chloride gas, and sulfuric acid.

The tank is prefilled with sulfuric acid.

Electromagnetic heating elements are embedded in the sidewall of the tank below the liquid surface, allowing for heating of both the sulfuric acid and the ammonium bisulfate generated during the reaction.

At the center of the tank, a rotating blade column is installed:

The base of the column is mounted on a bearing located at the protruding center of the tank floor.

The top of the column is supported by another bearing mounted on the top center of the tank.

The rotating column is thus axially fixed and capable of slow rotation.

Below the sulfuric acid surface, multiple agitator blades are arranged circumferentially and in multiple vertical layers along the rotating column.

Each blade is internally equipped with resistance wires for heating the contents of the tank.

The top of the rotating column is connected to a gear disk, which is driven by a motor mounted on the tank roof, providing slow rotational motion.

The tank roof also includes:

Pipelines leading to the ammonia gas storage tank and hydrogen chloride gas storage tank, each equipped with a gas pump to extract and transport the respective gases after reaction.

Two sets of ammonium chloride feed pipes, which extend into the tank. At the outlet of each pipe, a distributor is installed and motor-driven to evenly disperse the solid ammonium chloride into the tank.

The feed pipes are connected to the solid collection system of the ammonium chloride crystallization precipitation tank and are hermetically sealed to prevent leakage.

To ensure a stable and guaranteed gas supply, the reaction tank may also be connected to:

A liquid ammonia reserve tank, with a high-pressure gas pump to transfer generated ammonia gas into the reserve.

A liquid hydrogen chloride reserve tank, with a high-pressure pump for transferring hydrogen chloride gas likewise.

In special cases such as maintenance or downtime, the liquid ammonia reserve tank can supply ammonia gas to the ammonia gas storage tank, and the liquid hydrogen chloride reserve tank can supply hydrogen chloride gas to the hydrogen chloride gas storage tank.

### Dual Reaction Tank Configuration and Reserve Gas Storage Tanks

To enhance the reliability and continuity of the system, two reaction tanks are installed and operated simultaneously. The tanks alternate their roles during operation:

When Reaction Tank #1 is generating ammonia gas, Reaction Tank #2 is generating hydrogen chloride gas.

Conversely, when Reaction Tank #1 is generating hydrogen chloride gas, Reaction Tank #2 is generating ammonia gas.

### (2) Ammonia Gas Storage Tank and Hydrogen Chloride Gas Storage Tank

These tanks are configured as previously described.

### (3) Liquid Ammonia Reserve Tank

The liquid ammonia reserve tank is a cylindrical steel container, lined with fiberglass, stainless steel, or resin to resist corrosion from ammonia and hydrogen chloride gases.

The tank is filled with liquid ammonia and maintained at a pressure of at least 1.1 MPa, ensuring that the ammonia remains in liquid form at ambient temperature.

When it is necessary to supply ammonia gas from the reserve tank to the ammonia gas storage tank, a valve located on the top pipeline of the reserve tank is opened to complete the transfer.

When refilling is required, a high-pressure gas pump is used to extract ammonia gas generated in the reaction tank and inject it into the reserve tank. The gas is then compressed continuously to induce liquefaction inside the reserve tank.

### (4) Liquid Hydrogen Chloride Reserve Tank

The liquid hydrogen chloride reserve tank is also a cylindrical steel container, lined with corrosion-resistant materials such as fiberglass, stainless steel, or resin.

The tank is filled with liquid hydrogen chloride, maintained at a pressure of at least 4.2 MPa, keeping the gas in liquid state under ambient temperature.

When it is necessary to supply hydrogen chloride gas from the reserve tank to the hydrogen chloride gas storage tank, a valve located on the top pipeline of the reserve tank is opened.

When the reserve tank requires refilling, a high-pressure gas pump draws hydrogen chloride gas from the reaction tank and injects it into the reserve tank while maintaining continuous pressure to achieve liquefaction.

### Embodiment 1

Embodiment 1 describes a vertical power and power generation system that is not limited by terrain conditions.

This vertical system may be constructed as an underground configuration, an aboveground configuration, or a hybrid configuration combining both underground and aboveground installations.

In this embodiment, the underground configuration is taken as an example.

The system comprises:
an ammonia gas storage tank, an ammonia gas-powered well, a hydrogen chloride gas storage tank, a hydrogen chloride gas-powered well, a gravity block lifting shaft, a gravity block falling shaft, a generator system, an ammonia-containing ammonium chloride solution tank, a hydrochloric acid-containing ammonium chloride solution tank, an ammonium chloride crystallization and precipitation tank, an ammonium chloride solution storage tank, and reaction tanks.

The ammonia gas storage tank has a diameter of 20 meters and a height of 20 meters, maintained at a pressure of 1 to 2 atmospheres (100-200 kPa). It can store 6,280 to 12,560 m³ of ammonia gas at standard atmospheric pressure, which is 1.6 to 3.2 times the volume of the ammonia-powered well.

One end of the storage tank is connected via a pipeline to the ammonia gas-powered well for gas supply, and the other end is connected to Reaction Tank #1 and #2, which regenerate ammonia gas back into the tank.

The hydrogen chloride gas storage tank also has a diameter of 20 meters and a height of 20 meters, maintained at 1 to 2 atmospheres of pressure. It can store 6,280 to 12,560 m³ of hydrogen chloride gas, which is 1.6 to 3.2 times the capacity of the hydrogen chloride-powered well.

One end is connected to the hydrogen chloride-powered well, and the other to Reaction Tanks #1 and #2 for replenishment.

The ammonia-powered well has an inner diameter of 10 meters. The bottom of the well contains 10 meters of ammonium chloride solution, serving as the absorption medium for ammonia gas. This volume of solution is sufficient to absorb the total volume of ammonia required for one day of operation.

The piston stroke is 50 meters, and the piston diameter is 10 meters, giving the working chamber of the power well a volume of 3,925 m³.

In a vacuum state, the atmospheric pressure acting on the piston is 809 tons. Considering operational efficiency and the fact that full vacuum cannot be achieved in practice, the vacuum level is set at 70%, resulting in an effective pressure differential of 809×70%=566 tons. This value determines the standard lifting weight of the gravity block, i.e., 566 tons (for simplicity, the weight of the piston assembly is neglected).

The hydrogen chloride-powered well shares the same specifications as the ammonia-powered well.

The gravity block is a reinforced concrete block with dimensions of 5.5×5.5×7.5 meters, and a total weight of 566 tons.

The gravity block lifting shaft is a rectangular shaft with internal dimensions of 6.0×6.0 meters and a depth of 57.5 meters.

The gravity block falling shaft also has internal dimensions of 6.0×6.0 meters and a depth of 57.5 meters.

The ammonia-containing ammonium chloride solution tank has a diameter of 14 meters and a depth of 11 meters.

The hydrochloric acid-containing ammonium chloride solution tank has the same dimensions: 14 meters in diameter and 11 meters in depth.

The Ammonium Chloride Solution Mixing Tank, which receives both ammonia-containing and hydrochloric acid-containing solutions (also referred to as the Ammonium Chloride Solution Tank or Ammonium Chloride Crystallization Precipitation Tank), has a diameter of 20 meters and a sidewall depth of 11 meters. Its bottom is funnel-shaped, and at the bottom of the funnel is a centrifuge drum for collecting crystallized ammonium chloride solids, with a diameter of 4 meters.

The Ammonium Chloride Solution Storage Tank has a diameter of 14 meters and a depth of 11 meters.

### Initial System State:

The power well is filled with ammonium chloride solution to the designed liquid level. The piston is positioned at the upper limit within the well. The inflatable rubber bag inside the well is in an inflated, expanded state. The well is filled with ammonia gas at one standard atmosphere of pressure. The ammonium chloride solution storage tank is in a full state. The gravity block is located at the bottom of the gravity block lifting shaft.

To begin operation, the inflatable rubber bag is deflated, retracting from its expanded position covering the solution surface to contract along the fan well wall. The surface of the solution comes into contact with the ammonia gas within the well. As the ammonia dissolves into the ammonium chloride solution, the internal pressure of the well decreases. The piston begins to move downward. Through the steel cable and pulley system, the gravity block in the lifting shaft is raised. When the piston reaches the lower limit block within the power well, the gravity block reaches the top of the lifting shaft.

The movable track at the mouth of the lifting shaft is then shifted to align beneath the gravity block and engage with its wheels. The gravity block is transferred along the track that spans between the lifting shaft and the falling shaft to reach the entrance of the falling shaft. The track at the falling shaft is then retracted, allowing the gravity block to descend freely within the falling shaft. During descent, the gravity block drives the generator via the steel cable and pulley system, thereby generating electricity.

After reaching the bottom of the falling shaft, the gravity block is routed through the underground tunnel back to the bottom of the lifting shaft, restoring the system to its initial state and beginning the next cycle.

During the gravity block's power-generating descent, the inflatable rubber bag within the ammonia-powered well is re-inflated to isolate the liquid surface from the gas in the well. Meanwhile, the piston is raised by a motor connected to the truss pulley system at the mouth of the power well. During the piston's upward movement, ammonia gas is supplied from the storage tank to the well. When the piston reaches the upper limit, the well is restored to one standard atmosphere of ammonia gas, completing the cycle and preparing for the next.

Each ammonia-powered well completes one cycle in 12 minutes, i.e., five cycles per hour, and 110 cycles in a 22-hour operational day.

To further improve efficiency, a solution-aiding fan may be used during operation to accelerate the dissolution of ammonia gas, thereby increasing the number of daily cycles.

The ammonium chloride solution in the ammonia-powered well operates on a one-day replacement cycle, with 2 hours allocated for solution replacement. The solubility rate of ammonia decreases as the solution becomes saturated. If the natural dissolution rate becomes insufficient, the surface aeration fan can be activated to inject ammonia into the aeration ducts, thereby speeding up dissolution and reducing the total cycle time.

The operating process of the hydrogen chloride-powered well is similar to that of the ammonia-powered well, with the key difference being that hydrogen chloride gas is used instead of ammonia. Both gases dissolve into the ammonium chloride solution to create a partial vacuum that drives the piston downward.

One ammonia-powered well and one hydrogen chloride-powered well supply a single gravity-block falling shaft power generation system simultaneously.

By adjusting the falling speed of the gravity block, continuous operation of the system is maintained, ensuring the power well cycle time matches the electricity generation rate.

To improve system reliability, a number of gravity blocks may be stored on the ground as reserves.

The solution replacement timing for the ammonia-powered well and the hydrogen chloride-powered well can be staggered, and the replacement process can be scheduled during off-peak electricity hours, thereby ensuring uninterrupted power generation during system operation.

Alternatively, multiple such systems can be connected in parallel, and the solution replacement times across the systems can be staggered to achieve continuous power generation.

During the solution replacement for the ammonia-powered well, the used solution is pumped into the ammonia-containing ammonium chloride solution tank, and then the pre-stored saturated ammonium chloride solution from the ammonium chloride solution storage tank is injected into the well, completing the replacement process.

Similarly, during the solution replacement for the hydrogen chloride-powered well, the used solution is pumped into the hydrochloric acid-containing ammonium chloride solution tank, and then the pre-stored saturated ammonium chloride solution is injected into the hydrogen chloride-powered well from the ammonium chloride solution storage tank.

The pumping process of the ammonia-powered well and the filling process of the hydrogen chloride-powered well can be synchronized, and vice versa. In this way, the energy generated during water injection can be used to power the water extraction process, thereby reducing energy consumption during solution replacement.

The ammonia content in the ammonia-containing ammonium chloride solution tank and the hydrochloric acid content in the hydrochloric acid-containing ammonium chloride solution tank are measured. The solutions are then pumped into the ammonium chloride solution mixing tank (ammonium chloride crystallization precipitation tank) at a stoichiometric ratio such that the ammonia and hydrochloric acid will completely react. In the mixing tank, a chemical reaction between the ammonia and hydrochloric acid occurs, generating ammonium chloride, resulting in a supersaturated ammonium chloride solution.

Ammonium chloride crystals then precipitate out and are collected via a centrifuge drum at the bottom of the tank. The solid ammonium chloride is separated and stored. This solution regeneration cycle takes one day, which corresponds to the same period as the power well solution replacement cycle.

The collected solid ammonium chloride is delivered to Reaction Tanks #1 and #2. In the ammonia and hydrogen chloride gas regeneration system, chemical reactions occur to produce ammonia gas and hydrogen chloride gas, which are then transferred to their respective storage tanks, completing the cyclic utilization of gases.

Each reaction tank cycle lasts one day, matching the operational cycle of the ammonium chloride crystallization precipitation tank. That is, within a day, the crystallization tank can process all the solution replaced from the ammonia-powered and hydrogen chloride-powered wells, and deliver the generated ammonium chloride solids to the gas regeneration system in a timely manner.

The gas generation cycle within each reaction tank is 22 hours in total, consisting of 11 hours to generate ammonia gas and 11 hours to generate hydrogen chloride gas, which aligns with the 22-hour daily operation of the power well systems.

Reaction Tanks #1 and #2 operate in an alternating fashion. When Reaction Tank #1 is producing ammonia gas, Reaction Tank #2 is producing hydrogen chloride gas. When Reaction Tank #2 is producing ammonia gas, Reaction Tank #1 is producing hydrogen chloride gas.

This staggered operation mode ensures the synchronous operation and gas supply of the regeneration system with the power well system, thereby improving gas supply reliability and reducing energy consumption associated with gas storage.

In a single lift, the power well lifts a gravity block weighing 566 tons to a height of 50 meters, storing gravitational potential energy of 277,332,650 joules. With a generator efficiency of 95%, the gravitational energy converted to electrical energy is approximately 73 kWh per cycle.

With 110 cycles per day for a single power well, the daily power generation of a single well is 8,050 kWh.

As the described system includes one ammonia-powered well and one hydrogen chloride-powered well, the total daily electricity output of the system is 16,100 kWh, resulting in 5.88 million kWh per year.

During the operation of the system, the energy consumption for solution replacement in the power well, gas transmission between the reaction tank and gas storage tank, and from the gas storage tank to the power well is negligible.

The largest energy demand occurs during the regeneration of ammonia gas in the reaction tank, specifically when heating ammonium bisulfate to approximately 200° C. to induce decomposition and produce ammonia gas.

### Embodiment 2

Embodiment 2 describes a cost-efficient power generation system suitable for mountainous terrain, which utilizes the natural slope to reduce construction investment.

This embodiment takes an example with a slope height difference of 100 meters and a 1:1 gradient. In actual engineering, the slope rail system can be arranged flexibly along varying gradients and is not limited to a uniform slope.

This embodiment includes:
an ammonia gas storage tank, an ammonia-powered well, a hydrogen chloride gas storage tank, a hydrogen chloride-powered well, a gravity block lifting rail, a gravity block descent rail, a generator system, an ammonia-containing ammonium chloride solution tank, a hydrochloric acid-containing ammonium chloride solution tank, an ammonium chloride crystallization precipitation tank, an ammonium chloride solution storage tank, and reaction tanks.

The ammonia storage tank has a diameter of 34 meters and a height of 20 meters, with an internal pressure of 1-2 atmospheres (100-200 kPa).

It stores 18,150-36,298 m³ of ammonia gas under standard atmospheric conditions, equivalent to 1.6 to 3.2 times the capacity of the ammonia-powered well.

One end of the storage tank is connected to the ammonia-powered well to supply gas; the other end is connected to Reaction Tanks #1 and #2 to receive regenerated ammonia gas.

The hydrogen chloride gas storage tank is configured identically, storing 18,150-36,298 m³ of hydrogen chloride gas and connected similarly to the hydrogen chloride-powered well and reaction tanks.

The ammonia-powered well has a diameter of 10 meters. The depth of the ammonium chloride solution at the bottom is 30 meters, providing sufficient volume to dissolve the total ammonia gas used in a day.

The piston stroke is 141 meters, corresponding to a cylinder volume of 11,135 m³.

Assuming a 70% vacuum level is achievable during operation, the differential pressure force acting on the piston is 566 tons, serving as the lifting standard (piston self-weight ignored for simplicity).

The inclination of the lifting track is 1:1, or 45 degrees, so the gravity block mass is calculated as
566/sin(45°)=801, resulting in a gravity block weight of 801 tons.

The hydrogen chloride-powered well is configured with the same parameters as the ammonia-powered well.

The gravity block is constructed from reinforced concrete and has dimensions of 6.84×6.84×6.84 meters, with a mass of 801 tons.

The gravity block lifting rail, gravity block descent rail, foot-of-slope ground rail, and top-of-slope ground rail all utilize train-grade rail tracks. The bottom of the gravity block is equipped with two pairs of wheels, matching the rail gauge, and adopts train-type wheels for rail compatibility.

The ammonium chloride solution tank containing ammonia water has a diameter of 17 meters and a depth of 20 meters.

The ammonium chloride solution tank containing hydrochloric acid has the same dimensions: 17 meters in diameter and 20 meters deep.

The solution mixing tank—used for combining ammonia-containing and hydrochloric acid-containing solutions (also referred to as the ammonium chloride solution tank/ammonium chloride crystallization and sedimentation tank)—has a diameter of 20 meters, a side wall depth of 20 meters, and a funnel-shaped bottom. A centrifuge cylinder for recovering ammonium chloride solids is located at the funnel bottom, with a diameter of 4 meters.

The ammonium chloride solution storage tank has a diameter of 17 meters and a depth of 20 meters.

### System Initialization State:

The power well is filled to the designed liquid level with ammonium chloride solution.

The piston is at the uppermost limit position within the power well.

The inflatable rubber bag is in an inflated and expanded state, separating the gas and liquid phases.

The power well is charged with ammonia gas at one standard atmosphere.

The ammonium chloride solution storage tank is fully filled.

The gravity block is positioned at the bottom end of the lifting rail.

To begin operation, the rubber bag is deflated, contracting from its surface-covering state to the inner wall of the fan well.

As the ammonia gas comes into contact with the liquid surface and dissolves into the ammonium chloride solution, the internal gas pressure of the power well decreases, prompting the piston to descend. Through the cable and pulley system, the gravity block is lifted along the slope from the base to the top via the gravity block lifting rail.

When the piston reaches the bottom limit of the power well, the gravity block arrives at the top platform. The rail section carrying the gravity block rotates 90 degrees to align with the top-of-slope ground rail. The gravity block then travels along the ground rail to the top of the descent rail, where the rail again rotates 90 degrees to connect with the descent rail. The gravity block slides down the descent rail, and during this process, the cable and pulley system drives the generator to produce electricity.

Upon reaching the bottom platform, the rail again rotates 90 degrees to connect with the foot-of-slope ground rail, along which the gravity block travels to the base of the lifting rail, where the rail rotates once more to begin the next cycle.

During the descent and electricity generation phase, the inflatable rubber bag in the ammonia-powered well is reinflated, isolating the liquid from the gas inside the well. The piston is lifted using an electric motor connected to a pulley on the top truss beam. Simultaneously, ammonia gas is injected from the storage tank. When the piston reaches the upper limit, the power well again contains ammonia gas at one atmosphere, completing the cycle and resetting the system to its initial state.

The ammonia-powered well completes one cycle every 12 minutes, which equates to 5 cycles per hour, and 110 cycles per day assuming 22 hours of operation per day.

During operation, the dissolution booster fan can be activated to further accelerate the dissolution rate of ammonia gas, thereby increasing the cycle frequency.

The ammonium chloride solution in the ammonia-powered well has a replacement cycle of one day, with a solution replacement time of approximately two hours.

As the ammonia concentration in the solution increases, the natural dissolution rate of ammonia gas decreases. When this natural rate becomes insufficient for system demands, the surface aeration booster fan can be activated to inject ammonia gas into the aeration pipeline, thereby accelerating the dissolution process and shortening the cycle time.

The operating process of the hydrogen chloride-powered well is identical to that of the ammonia-powered well, except that hydrogen chloride gas is used to dissolve into ammonium chloride solution to generate a vacuum and produce power, instead of ammonia gas.

One ammonia-powered well and one hydrogen chloride-powered well jointly supply a gravity block descent power generation system. By adjusting the descent speed of the gravity block, the system can operate continuously, synchronizing the cycle duration of the power well with the power generation rate.

To further enhance system reliability, multiple gravity blocks can be stored at the top of the slope in reserve.

The solution replacement schedules of the ammonia-powered well and the hydrogen chloride-powered well are staggered. Moreover, the replacement operations are conducted during off-peak electricity demand periods, ensuring uninterrupted power generation throughout the operation.

Alternatively, multiple such systems can be arranged in parallel, with staggered replacement times, to achieve continuous power generation.

When replacing the solution in the ammonia-powered well, the used solution is pumped into the ammonium chloride solution tank containing ammonia water, after which a pre-stored saturated ammonium chloride solution from the ammonium chloride solution storage tank is injected into the ammonia-powered well to complete the exchange.

Similarly, when replacing the solution in the hydrogen chloride-powered well, the used solution is pumped into the ammonium chloride solution tank containing hydrochloric acid, and pre-stored saturated ammonium chloride solution is injected from the storage tank into the hydrogen chloride-powered well.

The solution extraction process from the ammonia-powered well can be performed simultaneously with the solution injection process into the hydrogen chloride-powered well, and vice versa. This recovers energy from the injection process to offset the pumping energy of the extraction process, thereby reducing the net energy consumption during solution replacement.

The ammonia content in the ammonia water-containing ammonium chloride solution tank, and the hydrochloric acid content in the hydrochloric acid-containing ammonium chloride solution tank, are measured and proportioned based on their stoichiometric reaction ratio. The respective solutions are then pumped into the mixed solution tank (also referred to as the ammonium chloride solution tank/ammonium chloride crystallization and sedimentation tank), where a chemical reaction between ammonia and hydrogen chloride occurs, forming ammonium chloride.

This results in a supersaturated ammonium chloride solution, which leads to crystallization and sedimentation of ammonium chloride within the tank. The solid ammonium chloride is separated and collected via the centrifuge cylinder at the bottom of the tank.

This solution regeneration system completes one cycle per day, consistent with the solution replacement cycle of the power wells.

The collected ammonium chloride solids are conveyed to Reaction Vessels #1 and #2, where ammonia gas and hydrogen chloride gas are regenerated in the ammonia and hydrogen chloride gas regeneration system, and subsequently transported to the corresponding ammonia gas storage tank and hydrogen chloride gas storage tank, thereby completing the cyclical reuse of these gases.

The reaction cycle of the reaction vessels is one day, which aligns with the operating cycle of the ammonium chloride crystallization and sedimentation tank. That is, the crystallization tank can process the used solution replaced daily from both the ammonia-powered well and the hydrogen chloride-powered well, and deliver the resulting ammonium chloride solids to the regeneration system throughout the day.

The reaction vessels require 11 hours to complete the ammonia gas production process, and another 11 hours for the hydrogen chloride gas production, totaling 22 hours, which matches the operating time of the power well system. Reaction Vessels #1 and #2 operate in a staggered manner, such that when Vessel #1 is producing ammonia gas, Vessel #2 is producing hydrogen chloride gas, and vice versa. This arrangement enables the gas regeneration system to run synchronously with the power well system, ensuring continuous gas supply, improving gas availability, and reducing energy consumption during gas storage.

In a single cycle, the power well lifts a gravity block weighing 801 tons to a height of 100 meters, storing potential energy equivalent to 784,727,702 joules. With a generator efficiency of 95%, this translates to approximately 207 kilowatt-hours (kWh) of usable electricity per cycle.

With 110 cycles per day, a single power well can generate 22,800 kWh of electricity daily. Given that the system includes one ammonia-powered well and one hydrogen chloride-powered well, the total daily output is 45,600 kWh, or approximately 16.63 million kWh per year.

Throughout the operation of the system, energy consumption for solution replacement, gas transfer between the reaction vessels and storage tanks, and between the storage tanks and power wells is negligible. The primary energy demand arises from heating ammonium bisulfate in the reaction vessel to approximately 200° C. to facilitate its decomposition during ammonia gas production.

### Embodiment 3

In Embodiment 1, the power well requires construction of a vertical shaft below ground level or a complex aboveground supporting structure. In Embodiment 2, the power well must be constructed along a mountainside slope, which can be challenging if the terrain is uneven.

Both Embodiments 1 and 2 face challenges due to the complexity and high cost of constructing the power well.

As an optimization, the power well can be constructed above ground, as shown in FIG. 11.

In this example, based on a horizontal ground level, the portion of the power well below the inflatable rubber bag is vertically arranged, similar to the vertical-type power well. The piston stroke section of the power well is arranged horizontally along the ground, forming a 90-degree angle with the solution tank. This layout places the majority of the power well above ground, greatly reducing construction difficulty and cost.

If the ground has a certain slope, the piston stroke section of the power well may also be laid out along the slope, forming an obtuse angle or acute angle with the vertical solution tank.

The operating process of this embodiment is the same as that in Embodiments 1 and 2.

### Embodiment 4

In Embodiments 1 and 2, the power well is used to lift a gravity block, store potential energy, and then convert this potential energy into kinetic energy via the descending gravity block to generate electricity.

In Embodiment 4, the power well directly drives a crankshaft connected to the piston, enabling direct mechanical power output from the power well. See FIGS. 12 and 13.

This example uses four ammonia-powered wells, arranged in parallel.

Each power well's piston is connected to a common crankshaft via a connecting rod.

Power Wells #1 and #4 operate as one group with synchronized status, and Wells #2 and #3 operate as another group.

### Initial State:

Pistons in Power Wells #1 and #4 are at the lower limit.

Pistons in Power Wells #2 and #3 are at the upper limit.

Start by deflating the inflatable rubber bags in Power Wells #2 and #3, allowing them to retract from the liquid surface to the inner wall of the fan shaft.

Ammonia gas dissolves into the ammonium chloride solution, creating a negative pressure in the well.

Under atmospheric pressure, the pistons move downward, rotating the crankshaft and outputting mechanical energy.

When the pistons reach the lower limit, the inflatable rubber bags are re-inflated, spreading across the liquid surface.

The pistons then move upward, driven by the crankshaft, while ammonia gas is injected into the power well to maintain 1 atmosphere of internal pressure.

Once the pistons reach the upper limit, ammonia injection is stopped, completing one cycle.

Then, switch to Power Wells #1 and #4:

Inflate the rubber bags, pistons move up while ammonia gas is injected. When pistons reach the top, stop gas injection and deflate the rubber bags. Ammonia dissolves into the solution, forming a vacuum, and the pistons descend, rotating the crankshaft to output power. Once the pistons reach the lower limit, a full cycle ends and a new one begins.

Power Wells #1/#4 and #2/#3 run in alternating, synchronized cycles.

During downward piston motion, dissolution-assist fans may be activated to accelerate gas dissolution and control the speed of piston movement.

As in previous embodiments, the system includes ammonia and hydrogen chloride gas regeneration systems, enabling continuous operation of the power wells.

This embodiment's mechanical operation resembles that of an internal combustion engine:

However, unlike combustion engines, which are thermal machines with small cylinder volumes and high speeds, this system operates with large cylinder volumes and low speed, relying on gas dissolution and vacuum formation to perform work.

This embodiment may be used for direct electricity generation, ship propulsion, or mechanical applications in fields such as mining or heavy machinery.

### Embodiment 5

### Ammonia and Hydrogen Chloride Gas Regeneration System

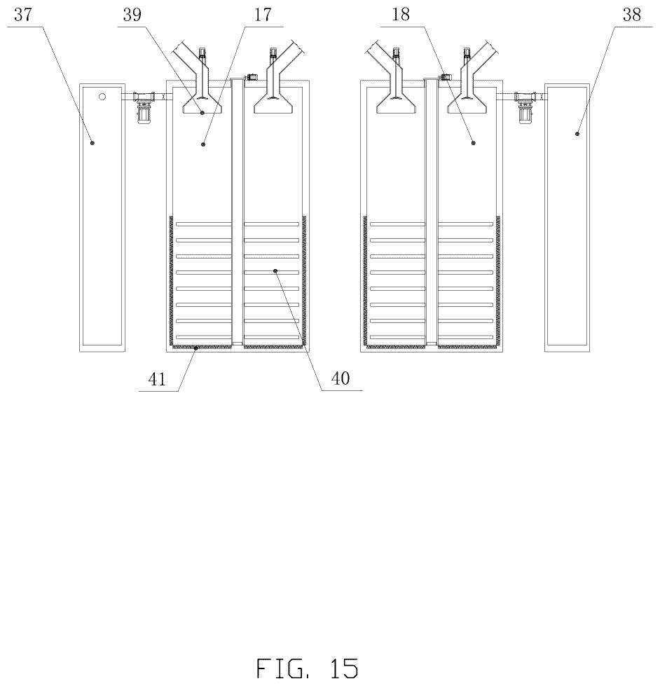

This embodiment relates to an ammonia and hydrogen chloride gas regeneration system, comprising two reaction tanks and auxiliary equipment including a liquid ammonia reserve tank, a liquid hydrogen chloride reserve tank, an ammonia storage tank, and a hydrogen chloride storage tank. See FIGS. 15, 16, and 17.

The liquid ammonia reserve tank and the liquid hydrogen chloride reserve tank are cylindrical steel tanks, with internal linings made of fiberglass, stainless steel, or resin, resistant to corrosion from ammonia and hydrogen chloride gases. These reserve tanks are optional and intended to enhance the supply reliability of the system. Their volume and necessity may be determined based on the operational requirements of the power well system.

The ammonia storage tank and hydrogen chloride storage tank serve as buffer systems between the reaction tanks and the power wells, temporarily storing the ammonia and hydrogen chloride gases generated in the reaction tanks. To enhance supply stability, the internal pressure of these storage tanks may be maintained between 100-200 kPa. During the upward stroke of the power well piston, the storage tank supplies gas from the reaction tank to the power well. During the downward stroke, the power well does not require gas input, and the gases produced by the reaction tanks are temporarily stored in the storage tanks.

### Chemical Reaction Process in the Reaction Tank:

The tank contains sulfuric acid. Solid ammonium chloride crystals generated in the ammonium chloride crystallization precipitation tank of the power well system are fed into the tank, where they react with the sulfuric acid to form ammonium bisulfate and hydrogen chloride gas, according to the reaction equation:

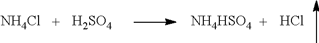

The generated HCl gas is extracted and delivered to the hydrogen chloride storage tank via pipeline.

The residual substance in the tank is ammonium bisulfate. Upon heating to approximately 200° C., it thermally decomposes into ammonia gas and sulfuric acid. The generated ammonia gas is pumped to the ammonia storage tank via gas pipeline. After the decomposition, sulfuric acid remains, returning the reaction tank to its initial state.

### Example (Based on Embodiment 1)

A pair of reaction tanks is provided, and the processing capacity of the pair is sufficient to regenerate the daily output of ammonium chloride from one ammonia power well and one hydrogen chloride power well system.

Daily ammonia consumption: 334 tons

Daily hydrogen chloride gas consumption: 640 tons

Total daily ammonium chloride generation: 974 tons

Each reaction tank processes: 487 tons

Each reaction tank alternates between producing ammonia gas and hydrogen chloride gas over 11 hours each, corresponding to the 22-hour operational cycle of the power well system.

When Tank #1 is producing ammonia gas, Tank #2 is producing hydrogen chloride gas, and vice versa.

To fully react 487 tons of ammonium chloride, at least 891 tons of sulfuric acid is needed.

The reaction tank has a diameter of 10 meters, and conservatively contains 1000 tons of sulfuric acid, with a density of 1840 kg/m³, resulting in an acid depth of 6.9 meters.

After the reaction, 487 tons of NH₄Cl yields 1225 tons of ammonium bisulfate, with a density of 1780 kg/m³, reaching a height of 8.8 meters in the tank.

To allow for sufficient reaction volume and partial gas buffer space, the overall tank height is 20 meters.

### Reaction Cycle Operation:

Initial state: each of the two tanks contains 1000 tons of sulfuric acid.

### Tank #1:

Feeds 487 tons of ammonium chloride via the feed pipe and dispersing device at a rate of 0.74 t/min.

NH₄Cl reacts with sulfuric acid to form NH₄HSO₄ and HCl gas, which is pumped to the HCl storage tank.

After 11 hours: all NH₄Cl has reacted; only ammonium bisulfate remains.

Start the electromagnetic heating systems at the tank bottom, wall, and inside the stirring blades.

Heat ammonium bisulfate to ˜200° C. to thermally decompose into sulfuric acid and ammonia gas.

Ammonia gas is pumped to the ammonia storage tank.

Use layered heating, temperature control, and intermittent heating to regulate decomposition rate and complete the process in 11 hours.

For example, begin by heating the topmost stirring blade layer, then sequentially activate lower heating zones.

After all decomposition: only sulfuric acid remains, returning the tank to its initial state.

While Tank #1 is generating HCl gas, Tank #2 begins producing ammonia gas.

This alternating mode ensures the regeneration system runs continuously during the 22-hour power well cycle, forming a closed-loop regeneration and recycling system.

### Embodiment 6

### Heating Source System for the Reaction Tank

In the foregoing embodiments, the core energy-consuming process is the heating of ammonium bisulfate in the reaction tank to generate ammonia gas.

Given the operational characteristics of the system and the presence of gas storage subsystems, the entire system has extremely low stability requirements for the continuous operation of the power wells and the reaction tanks.

During the gas dissolution process in the power wells, operational stability is not critical—the process can be fast, slow, or intermittent.

Likewise, the heating and decomposition process of ammonium bisulfate in the reaction tank can also tolerate instability, being performed at variable speeds or even intermittently.

Taking Embodiment 1 as an example:

When the ammonia storage tank is pressurized to 200 kPa, its ammonia gas volume equals 3.2 times the volume required for one power well cycle. Thus, even without gas supply from the reaction tank, the stored ammonia can support three cycles, i.e., 36 minutes of continuous operation (one cycle=12 minutes). Hence, the reaction tank can pause for up to 30 minutes without affecting the system. Increasing the tank pressure or volume would further reduce the reliance on real-time gas supply.

Ammonia gas can be liquefied under mild conditions-1.06 MPa at 30° C.

1 cubic meter of liquid ammonia can be converted to 790 cubic meters of gaseous ammonia.

Thus, increasing liquid ammonia reserves greatly reduces the dependency on consistent ammonia gas generation.

For example, in Embodiment 1:

$$Daily ammonia gas consumption = 433 , 000 {m}^{3}$$

$$Two - day consumption = 866 , 000 {m}^{3}$$

$$Required liquid ammonia volume = 1 , 097 {m}^{3}$$

Hence, a single 1,100 m³ liquid ammonia reserve tank suffices for two days of system operation.

### CONCLUSION

The reaction tank's heating process to produce ammonia gas has low stability requirements, making it suitable for intermittent or variable renewable energy sources such as solar or wind power.

Additionally:

Coal combustion may be used as a direct heat source, yielding a thermal efficiency over 90%, which far exceeds conventional coal-fired power plants (˜40%). Thus, using coal directly for heating in this system achieves more than twice the efficiency compared to traditional thermal power generation.

The system can be integrated with thermal power plants, utilizing their exhaust gases or steam to heat the reaction tank via coiled piping.

The system can also be applied aboard ocean-going ships, using engine exhaust heat to heat the reaction tank, thus serving as an auxiliary power system and enhancing fuel utilization efficiency.

The system can also be miniaturized for trucks or small vehicles, serving as a vehicle power system.

### Embodiment 7

Thermal Efficiency Optimization and Co-generation Applications

In the previous embodiments, the gas temperature inside the power wells is assumed to be ambient (20° C.), without considering the temperature of gases generated by the reaction tanks.

If the system is scaled up and synchronized, the reaction process and power well operation can be conducted in parallel, thus maximizing energy utilization.

For example:

If the ammonia gas generated by the reaction tank is at 200° C., and it is immediately fed into the power well, then the working gas inside the well is also at 200° C.

At 1 atm, the density of ammonia is:

$$At 20 ° C . : 0.759 kg / {m}^{3}$$

$$At 200 ° C . : 0.439 kg / {m}^{3}$$

Thus, the mass of ammonia needed per unit volume at 200° C. is only 58% of that at 20° C.

This implies that synchronous operation of the reaction tank and power well at high temperature significantly reduces the required quantity of ammonia, hydrogen chloride, and sulfuric acid, thereby lowering overall energy consumption.

With large-scale deployment, the system can be integrated with other industries:
Fertilizer industry (via recovered ammonium salts)
District heating systems in cold regions

For instance:

During winter heating seasons in northern regions, the 200° C. ammonia gas in the power well can first be passed through a heat exchanger before dissolving in the solution, transferring heat to a heating facility.

Likewise, in the hydrogen chloride power well, heat generated during the dissolution of HCl gas (a highly exothermic process) can be captured by heat exchangers in the solution and transferred to the heating network.

By doing so, the system achieves combined heat and power (CHP) generation, significantly improving overall energy efficiency.

What is claimed is:

1. A piston-type gas-powered well-based energy storage and power generation system, comprising:
a gas-powered well having an internal sliding chamber for reciprocating movement of a piston assembly, the bottom of the sliding chamber being provided with a solution pool;
independent gas injection, liquid injection, and liquid discharge pipelines disposed within the wall of the gas-powered well, wherein the gas injection pipeline is configured to inject a gas highly soluble in water into the gas-powered well, with its outlet located at the bottom of the sliding chamber; the liquid injection pipeline's outlet is located at the bottom of the solution pool;
and the liquid discharge pipeline's inlet is located at the bottom of the solution pool;
a first truss beam disposed at the top of the gas-powered well to support the piston assembly, the first truss beam being provided with a first pulley;
a lifting well having an internal ascending channel for lifting a gravity block, the top of the lifting well being provided with a second truss beam, the second truss beam being provided with a second pulley;
a falling well having an internal descending channel for the gravity block to fall, the top of the falling well being provided with a third truss beam, the third truss beam being provided with a third pulley;
a track connecting the tops of the lifting well and the falling well, and a tunnel connecting the bottoms of the lifting well and the falling well, the tunnel allowing the gravity block to move from the bottom of the descending channel to the bottom of the ascending channel;
a piston assembly located within the sliding chamber of the gas-powered well, the piston assembly comprising a piston block, a connecting frame, support rollers, and a connecting rope, wherein the support rollers are mounted on the sidewall of the piston block, the piston block is connected to the inner wall of the sliding chamber via the support rollers, a sealing structure is disposed between the sidewall of the piston block and the inner wall of the sliding chamber, the sealing structure being located between a pair of support rollers, the connecting frame is fixed atop the piston block, one end of the connecting rope is fixed to the connecting frame, and the free end of the connecting rope is connected to the gravity block and is suspended in the lifting well via guidance by the first and second pulleys;
an isolation device located between the sliding chamber and the solution pool, the isolation device having a telescopic end face that isolates contact between the gas in the sliding chamber and the liquid in the solution pool;
a power generation device mounted above the falling well, the output shaft of the power generation device being connected to a drum, the drum being wound with a steel wire rope, one end of the steel wire rope being fixed to the drum, the steel wire rope having a connecting end connected to the gravity block, the connecting end of the steel wire rope being suspended in the falling well via guidance by the third pulley.

2. The piston-type gas-powered well-based energy storage and power generation system according to claim 1, wherein the sealing structure comprises a first sealing ring and a second sealing ring, both sleeved on the sidewall of the piston block, a watertight cavity for containing water being formed between the first sealing ring and the second sealing ring.

3. The piston-type gas-powered well-based energy storage and power generation system according to claim 2, wherein the piston block is provided with a water tank for containing water, the inner wall of the watertight cavity is provided with a communication hole, and the bottom of the water tank is connected to the watertight cavity via the communication hole.

4. The piston-type gas-powered well-based energy storage and power generation system according to claim 1, wherein the middle part of the solution pool is provided with a wind shaft, the bottom of the wind shaft being fixed to the bottom of the solution pool, and a fan being disposed inside the wind shaft.

5. The piston-type gas-powered well-based energy storage and power generation system according to claim 4, wherein a ventilation structure is radially arranged between the wind shaft and the solution pool, the ventilation structure being located below the isolation device, the ventilation structure comprising an air barrier layer, a ventilation pipe, and a sponge layer, the air barrier layer covering the sponge layer, the sponge layer being immersed in the water of the solution pool, the ventilation pipe being embedded in the sponge layer, the ventilation pipe being connected to the sidewall of the wind shaft, and the sidewall of the ventilation pipe being provided with air dispersion holes.

6. The piston-type gas-powered well-based energy storage and power generation system according to claim 5, wherein the isolation device comprises an inflatable rubber bag sleeved on the sidewall of the wind shaft, the inflatable rubber bag performing telescopic movement in the radial direction of the wind shaft under the control of an air pump.

7. The piston-type gas-powered well-based energy storage and power generation system according to claim 1, wherein the gas-powered well comprises an ammonia gas-powered well and a hydrogen chloride gas-powered well, the ammonia gas-powered well being correspondingly provided with a first lifting well, the hydrogen chloride gas-powered well being correspondingly provided with a second lifting well, the falling well being located between the first lifting well and the second lifting well; the top of the first lifting well is connected to the top of the falling well via a track, and the bottom of the first lifting well is connected to the bottom of the falling well via a tunnel; the top of the second lifting well is connected to the top of the falling well via a track, and the bottom of the second lifting well is connected to the bottom of the falling well via a tunnel.

8. The piston-type gas-powered well-based energy storage and power generation system according to claim 7, wherein an ammonia gas storage tank is disposed on one side of the ammonia gas-powered well, the ammonia gas storage tank being connected to the gas injection pipeline in the ammonia gas-powered well via a pipeline.

9. The piston-type gas-powered well-based energy storage and power generation system according to claim 8, wherein a hydrogen chloride gas storage tank is disposed on one side of the hydrogen chloride gas-powered well, the hydrogen chloride gas storage tank being connected to the gas injection pipeline in the hydrogen chloride gas-powered well via a pipeline.

10. The piston-type gas-powered well-based energy storage and power generation system according to claim 9, wherein a ammonium chloride solution storage pool is disposed between the ammonia gas-powered well and the hydrogen chloride gas-powered well, the ammonium chloride solution storage pool being connected to the liquid injection pipelines of the ammonia gas-powered well and the hydrogen chloride gas-powered well via pipelines to deliver ammonium chloride solution.

11. The piston-type gas-powered well-based energy storage and power generation system according to claim 10, wherein an ammonium chloride solution tank containing ammonia water is disposed on one side of the ammonia gas-powered well, the ammonium chloride solution tank being connected to the liquid discharge pipeline of the ammonia gas-powered well via a pipeline.

12. The piston-type gas-powered well-based energy storage and power generation system according to claim 11, wherein an ammonium chloride solution tank containing hydrochloric acid is disposed on one side of the hydrogen chloride gas-powered well, the ammonium chloride solution tank being connected to the liquid discharge pipeline of the hydrogen chloride gas-powered well via a pipeline.

13. The piston-type gas-powered well-based energy storage and power generation system according to claim 11, wherein a mixing pool is disposed between the ammonium chloride solution tank containing ammonia water and the ammonium chloride solution tank containing hydrochloric acid, the ammonium chloride solution tank containing ammonia water being connected to the mixing pool via a pipeline, the ammonium chloride solution tank containing hydrochloric acid being connected to the mixing pool via a pipeline, and the mixing pool being connected to the ammonium chloride solution storage pool via a pipeline.

14. The piston-type gas-powered well-based energy storage and power generation system according to claim 9, wherein a reaction tank is disposed between the ammonia gas-powered well and the hydrogen chloride gas-powered well, the reaction tank being connected to the ammonia gas storage tank via a pipeline, the reaction tank being connected to the hydrogen chloride gas storage tank via a pipeline, and the reaction tank, the ammonia gas storage tank, and the hydrogen chloride gas storage tank constitute a regeneration system for ammonia gas and hydrogen chloride gas.

15. The piston-type gas-powered well-based energy storage and power generation system according to claim 1, wherein the gas-powered well, the lifting well, and the falling well are all embedded below the ground surface.

16. The piston-type gas-powered well-based energy storage and power generation system according to claim 1, wherein the gas-powered well, the lifting well, and the falling well are all constructed along a mountain, and the power generation device is located at the top of the mountain slope.

17. A piston-type gas-powered well-based energy storage and power generation system, comprising:
a gas-powered well, a piston assembly, an isolation device, and a power generation device;
wherein the gas-powered well is arranged horizontally in an axial direction and comprises an internal sliding chamber for reciprocating motion of the piston assembly, a solution pool being arranged on one side of the sliding chamber, the solution pool and the sliding chamber forming an L-shaped structure, and a truss column configured to provide traction to the piston assembly being arranged on the other side of the gas-powered well, the truss column being provided with a steering pulley;
wherein the wall of the gas-powered well is provided with independent gas injection, liquid injection, and liquid discharge pipelines, the gas injection pipeline being used to inject a gas that is highly soluble in water into the gas-powered well, the outlet of the gas injection pipeline being located inside the sliding chamber, the outlet of the liquid injection pipeline being located at the bottom of the solution pool, and the inlet of the liquid discharge pipeline being located at the bottom of the solution pool;
wherein the power generation device is mounted on the truss column and an output shaft of the power generation device is connected to a drum;
wherein the piston assembly is located in the sliding chamber of the gas-powered well and comprises a piston block, a connecting frame, support rollers, and a connecting rope, the support rollers being mounted on the side wall of the piston block, the piston block being connected to the inner wall of the sliding chamber via the support rollers, a sealing structure being provided between the side wall of the piston block and the inner wall of the sliding chamber, the sealing structure being located between a pair of support rollers, the connecting frame being fixed on top of the piston block, one end of the connecting rope being fixed to the connecting frame, and the other end of the connecting rope being guided by the steering pulley and wound on the drum;
wherein the isolation device is located between the sliding chamber and the solution pool and has a telescopic end face configured to isolate the gas in the sliding chamber from contact with the liquid in the solution pool.

18. The piston-type gas-powered well-based energy storage and power generation system according to claim 17, wherein the sealing structure comprises a first sealing ring and a second sealing ring, both the first sealing ring and the second sealing ring being sleeved on the side wall of the piston block, and a watertight cavity for containing water being formed between the first sealing ring and the second sealing ring.

19. The piston-type gas-powered well-based energy storage and power generation system according to claim 18, wherein the piston block is provided with a water tank for containing water, and the inner wall of the watertight cavity is provided with a communication hole, and the bottom of the water tank is connected to the watertight cavity through the communication hole.

20. A piston-type gas-powered well-based energy storage and power generation system, comprising:
a gas-powered well, a piston assembly, an isolation device, a connecting rod, a crankshaft, and a power generation device;
wherein the gas-powered well comprises an internal sliding chamber for reciprocating motion of the piston assembly, a solution pool being disposed at the bottom of the sliding chamber, and the wall of the gas-powered well being provided with independent gas injection, liquid injection, and liquid discharge pipelines, the gas injection pipeline being used to inject a gas that is highly soluble in water into the gas-powered well, the outlet of the gas injection pipeline being located at the bottom of the sliding chamber, the outlet of the liquid injection pipeline being located at the bottom of the solution pool, and the inlet of the liquid discharge pipeline being located at the bottom of the solution pool;
wherein the piston assembly is located in the sliding chamber of the gas-powered well and comprises a piston block, a connecting frame, support rollers, a connecting rod, and a crankshaft, the support rollers being mounted on the side wall of the piston block, the piston block being connected to the inner wall of the sliding chamber via the support rollers, a sealing structure being provided between the side wall of the piston block and the inner wall of the sliding chamber, the sealing structure being located between a pair of support rollers, the connecting frame being fixed on top of the piston block, and the connecting frame being connected to the crankshaft via the connecting rod;
wherein the isolation device is located between the sliding chamber and the solution pool and has a telescopic end face configured to isolate the gas in the sliding chamber from contact with the liquid in the solution pool;
wherein an output shaft of the power generation device is connected to one end of the crankshaft.
